(19) United States
(12) Patent Application Publication
(10) Pub. No.: US 2026/0315909 A1
(43) Pub. Date: Oct. 15, 2026

(54) PIECE ASSIGNMENT IN COMPUTER-IMPLEMENTED INTERACTIVE ENVIRONMENT

(71) Applicant: TENCENT TECHNOLOGY (SHENZHEN) COMPANY LIMITED, Shenzhen (CN)

(72) Inventor: Ziqi WEI, Shenzhen (CN)

(73) Assignee: TENCENT TECHNOLOGY (SHENZHEN) COMPANY LIMITED, Shenzhen (CN)

(21) Appl. No.: 19/684,655

(22) Filed: May 21, 2026

Related U.S. Application Data
(63) Continuation of application No. PCT/CN2025/084308, filed on Mar. 24, 2025.

(30) Foreign Application Priority Data
May 17, 2024 (CN) 202410621390.8

(51) Int. Cl. A63F 3/00

(52) U.S. Cl. CPC A63F 3/00643

(57) ABSTRACT

In a method for piece assignment, a first game page is displayed, the first game page including a plurality of piece areas and a plurality of corresponding candidate areas, at least the plurality of piece areas or the plurality of candidate areas being in a moving state. Whether a number of selected candidate areas selected by the one or more virtual characters reaches a reference number is determined. A second game page is displayed when the number is determined to reach the reference number, the second game page including the plurality of candidate areas and the plurality of piece areas in a stationary state, each one of the plurality of piece areas displaying a respective piece. In the method, a piece corresponding to the respective candidate area is assigned to a respective one of the one or more virtual characters selecting the candidate area.

### RELATED APPLICATIONS

The present application is a continuation of International Application No. PCT/CN2025/084308, filed on Mar. 24, 2025, which claims priority to Chinese Patent Application No. 202410621390.8, filed on May 17, 2024, and entitled “METHOD AND APPARATUS FOR PIECE ASSIGNMENT FOR TURN-BASED BOARD GAME, DEVICE, AND STORAGE MEDIUM.” The entire disclosures of the prior applications are hereby incorporated by reference.

### FIELD OF THE TECHNOLOGY

Embodiments of this disclosure relate to the field of computer technologies, including a method and apparatus for piece assignment for a turn-based board game, a device, and a storage medium.

### BACKGROUND

A computer-implemented interactive environment includes a turn-based board game, which is an emerging board game. In such a game, pieces (also referred to as virtual objects) are assigned to users based on selection operations of game players for game deployment, and two opposing sides place the pieces on a board. The game application automatically controls the pieces of both sides on the board to battle, and displays battle results.

### SUMMARY

Embodiments of this disclosure include a method and apparatus for piece assignment for a turn-based board game, a device, and a storage medium, so as to improve the human-computer interaction efficiency.

In an aspect, an embodiment of this disclosure provides a method for piece assignment in a computer-implemented interactive environment. In the method, a first game page of the computer-implemented interactive environment is displayed, the first game page including a plurality of piece areas and a plurality of corresponding candidate areas, the plurality of candidate areas being selectable by one or more virtual characters, and at least the plurality of piece areas or the plurality of candidate areas being in a moving state. Whether a number of selected candidate areas of the plurality of candidate areas selected by the one or more virtual characters reaches a reference number is determined. A second game page of the computer-implemented interactive environment is displayed when the number of the selected candidate areas is determined to reach the reference number, the second game page including the plurality of candidate areas and the plurality of piece areas in a stationary state, each one of the plurality of piece areas displaying a respective piece and corresponding to a respective one of the plurality of candidate areas. In the method, a piece corresponding to the respective candidate area is assigned by processing circuitry to a respective one of the one or more virtual characters selecting the candidate area.

In an aspect, an embodiment of this disclosure provides an apparatus for piece assignment in a computer-implemented interactive environment. The apparatus includes processing circuitry configured to display a first game page of the computer-implemented interactive environment, the first game page including a plurality of piece areas and a plurality of corresponding candidate areas, the plurality of candidate areas being selectable by one or more virtual characters, and at least the plurality of piece areas or the plurality of candidate areas being in a moving state. The processing circuitry is configured to determine whether a number of selected candidate areas of the plurality of candidate areas selected by the one or more virtual characters reaches a reference number. The processing circuitry is configured to display a second game page of the computer-implemented interactive environment when the number of the selected candidate areas is determined to reach the reference number, the second game page including the plurality of candidate areas and the plurality of piece areas in a stationary state, each one of the plurality of piece areas displaying a respective piece and corresponding to a respective one of the plurality of candidate areas. The processing circuitry is configured to assign a piece corresponding to the respective candidate area to a respective one of the one or more virtual characters selecting the candidate area.

In an aspect, an embodiment of this disclosure provides a non-transitory computer-readable storage medium. The non-transitory computer-readable storage medium stores instructions, which when executed by a processor, cause the processor to perform a method for piece assignment in a computer-implemented interactive environment. In the method, a first game page of the computer-implemented interactive environment is displayed, the first game page including a plurality of piece areas and a plurality of corresponding candidate areas, the plurality of candidate areas being selectable by one or more virtual characters, and at least the plurality of piece areas or the plurality of candidate areas being in a moving state. Whether a number of selected candidate areas of the plurality of candidate areas selected by the one or more virtual characters reaches a reference number is determined. A second game page of the computer-implemented interactive environment is displayed when the number of the selected candidate areas is determined to reach the reference number, the second game page including the plurality of candidate areas and the plurality of piece areas in a stationary state, each one of the plurality of piece areas displaying a respective piece and corresponding to a respective one of the plurality of candidate areas. In the method, a piece corresponding to the respective candidate area is assigned to a respective one of the one or more virtual characters selecting the candidate area.

In an aspect, an embodiment of this disclosure provides a method for piece assignment for a turn-based board game, the method being performed by a computer device and including: displaying a first game page, the first game page including a piece area and a candidate area configured for selection by a virtual character, and at least one of the piece area or the candidate area being in a moving state; displaying a second game page in response to the candidate area being selected, the second game page including a candidate area and a piece area in a stationary state, the piece area displaying at least one piece, and one piece corresponding to one candidate area; and assigning a piece corresponding to the candidate area to a virtual character selecting the candidate area.

In another aspect, an embodiment of this disclosure provides an apparatus for piece assignment for a turn-based board game, the apparatus including: a first display module configured to display a first game page, the first game page including a piece area and a candidate area configured for selection by a virtual character, and at least one of the piece area or the candidate area being in a moving state; a second display module configured to display a second game page in response to the candidate area being selected, the second game page including a candidate area and a piece area in a stationary state, the piece area displaying at least one piece, and one piece corresponding to one candidate area; and an assignment module configured to assign a piece corresponding to the candidate area to a virtual character selecting the candidate area.

In another aspect, an embodiment of this disclosure provides a computer device, including a processor (an example of processing circuitry) and a memory, the memory having at least one program code stored therein that is loaded and executed by the processor to cause the computer device to implement the method for piece assignment for a turn-based board game described above.

In another aspect, further provided is a non-volatile computer-readable storage medium (e.g., non-transitory computer-readable storage medium), having at least one program code stored therein that is loaded and executed by a processor to cause a computer to implement the method for piece assignment for a turn-based board game described above.

In another aspect, further provided is a computer program or a computer program product, having at least one computer instruction stored therein that is loaded and executed by a processor to cause a computer to implement the method for piece assignment for a turn-based board game described above.

In the embodiments of this disclosure, during the piece assignment process, at least one of the candidate area or the piece area is in the moving state. After a virtual character selects a candidate area, the candidate areas and the piece areas in the stationary state are displayed, and the piece displayed in the piece area corresponding to the candidate area selected by the virtual character is assigned to the virtual character. The randomness of the piece assignment process is improved. By having the candidate areas and/or the piece areas in the moving state, the fun and diversity of the piece assignment process are increased, thereby improving the human-computer interaction efficiency.

### BRIEF DESCRIPTION OF THE DRAWINGS

FIG. 1 is a schematic diagram of a computer system according to an embodiment of this disclosure.

FIG. 2 is a flowchart of a method for piece assignment for a turn-based board game according to an embodiment of this disclosure.

FIG. 3 is a schematic diagram of a first game page according to an embodiment of this disclosure.

FIG. 4 is a schematic diagram of another first game page according to an embodiment of this disclosure.

FIG. 5 is a schematic diagram of another first game page according to an embodiment of this disclosure.

FIG. 6 is a schematic diagram of a faction selection page according to an embodiment of this disclosure.

FIG. 7 is a schematic diagram of a selection page including time information according to an embodiment of this disclosure.

FIG. 8 is a schematic diagram of another selection page including time information according to an embodiment of this disclosure.

FIG. 9 is a schematic diagram of a selection page after a first round ends according to an embodiment of this disclosure.

FIG. 10 is a schematic diagram of another selection page after a first round ends according to an embodiment of this disclosure.

FIG. 11 is a schematic diagram of a selection page for a second round according to an embodiment of this disclosure.

FIG. 12 is a schematic diagram of a second game page according to an embodiment of this disclosure.

FIG. 13 is a schematic diagram of a third game page according to an embodiment of this disclosure.

FIG. 14 is a flowchart of a method for piece assignment for a turn-based board game according to an embodiment of this disclosure.

FIG. 15 is a schematic structural diagram of an apparatus for piece assignment for a turn-based board game according to an embodiment of this disclosure.

FIG. 16 is a schematic structural diagram of a terminal device according to an embodiment of this disclosure.

FIG. 17 is a schematic structural diagram of a server according to an embodiment of this disclosure.

### DETAILED DESCRIPTION

To describe the objectives, technical solutions, and advantages of this disclosure, aspects of this disclosure will be described in further detail with reference to the accompanying drawings.

Examples of terms involved in the aspects of the disclosure are briefly introduced. The descriptions of the terms are provided as examples only and are not intended to limit the scope of the disclosure.

Turn-Based Board Game: A turn-based board game may correspond to an example of computer-implemented interactive environment and may refer to a board game in which “pieces” are pre-arranged before the battle, and during the battle, the “pieces” automatically engage in combat according to the pre-arrangement. A “piece” is typically represented by a virtual object, which may be referred to, for example, as a virtual hero. During the battle, the virtual objects automatically cast various skills to battle. The battle is typically turn-based. When all “pieces” on one side are defeated (e.g., the health points of the virtual objects are reduced to zero), this side is considered the loser of the current turn. In some embodiments, in addition to the “piece type virtual objects” used for a battle, each of the two opposing sides is further provided with a player character representing the current user participating in the battle. The player character is not moved to the battle area or the piece candidate area as a “piece”. The player character is also provided with health points (or hit points). The health points of the player character are correspondingly reduced (in case of a battle loss) or remain unchanged (in case of a battle win) based on the outcome of each battle. When the health points of this player character are reduced to zero, the user corresponding to the player character withdraws from the battle, and the remaining users continue the battle. In one embodiment, the turn-based board game includes auto chess. In some embodiments, users may alternatively be referred to as game players or game objects.

Auto Chess: An auto chess may correspond to a computer-implemented interactive environment that is a turn-based competitive multiplayer game with in-game trading of hero pieces. For example, the game involves eight or six users (also referred to as game players), each occupying an area on the board. Two users among a plurality of users engage in a one-on-one battle. Each turn of a battle includes a preparation phase, a battle phase, and a selection phase. During the preparation phase, the users purchase pieces (e.g., heroes in the interactive environment) from a store and arrange lineups on the board. During the selection phase, a selection area includes a plurality of pieces, and the users select pieces based on a particular sequence (for example, an ascending sequence of hit points), to obtain new pieces. During the battle phase, after the lineups of both sides are locked, the pieces automatically engage in combat until all pieces on one side are defeated. The side whose pieces are all defeated is the loser of the turn and will have a particular number of hit points deducted. The game turns repeat continuously, matching users with new opponents, until a user is eliminated when the user's health points are ≤0. The last remaining user wins the game (achieves 1^{st} place).

Board: A board may refer to an area within the battle interface of a turn-based board game used for preparing for and conducting battles. The board may be any one of a two-dimensional virtual board, a 2.5-dimensional virtual board, and a three-dimensional virtual board. This is not limited in this disclosure.

Equipment: In auto chess games, each piece may wear 3 (or other numbers of) pieces of equipment. Equipment may provide attributes or effects to the hero (i.e., piece), such as attack, defense, health points, healing, penetration, and shield.

Player: A player may refer to a virtual character played (or controlled) by a user. Each player possesses different special abilities that can assist the user in playing the game more effectively. In some embodiments, a player may alternatively be referred to as a player virtual character, a player character, or the like.

In some scenarios, during a turn of a turn-based board game, the order of the assigned pieces may be determined based on the hit points of virtual characters controlled by game players. Game players corresponding to virtual characters with fewer hit points may have priority in selection, allowing them to more specifically choose pieces that can turn the situation around, thereby increasing the chance of a comeback. In contrast, there may be a limited number of pieces for selection by game players corresponding to virtual characters with more hit points. The order in which game players select pieces may be fixed, which confines the comeback opportunity to game players corresponding to virtual characters with fewer hit points. As a result, the results of piece assignment tend to be predictable, limiting the balance and diversity of the game.

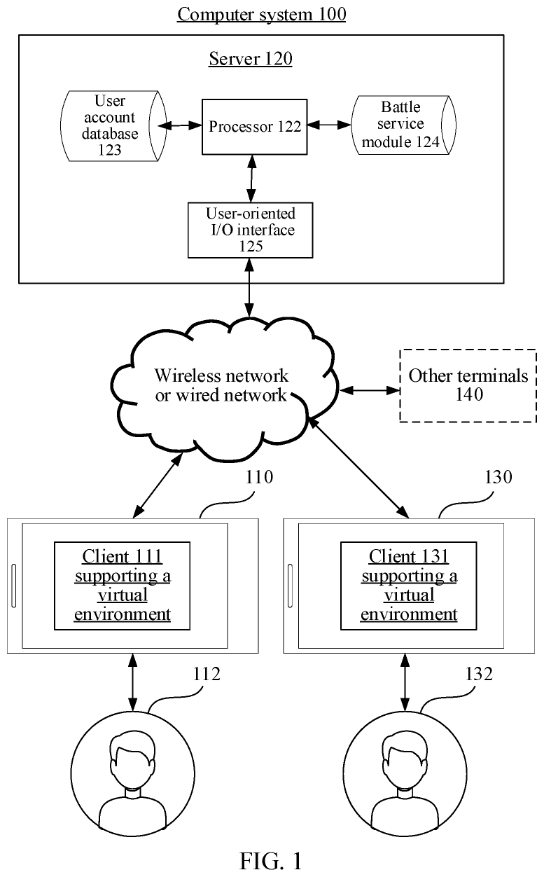

FIG. 1 is a structural block diagram of a computer system according to an embodiment of this disclosure. The computer system 100 includes a first terminal 110, a server 120, and a second terminal 130.

A client 111 supporting a virtual environment is installed and runs on the first terminal 110. The client 111 may be a program of a turn-based board game. When the first terminal 110 runs the client 111, a user interface of the client 111 is displayed on the screen of the first terminal 110. The client 111 may be a client of an auto chess game. The first terminal 110 is a terminal used by a first user 112. The first user 112 acquires pieces using the first terminal 110 during a preparation phase and a selection phase of a battle, and arranges the pieces in a battle area of a board during a preparation phase of the battle. The first terminal 110 or the server 120 automatically controls the pieces to battle during the battle phase according to attributes, skills, and arrangement of the pieces in the battle area.

A client 131 supporting a virtual environment is installed and runs on the second terminal 130. The client 131 may be a program of a turn-based board game. When the second terminal 130 runs the client 131, a user interface of the client 131 is displayed on the screen of the second terminal 130. The client 131 may be a client of an auto chess game. The second terminal 130 is a terminal used by a second user 132. The second user 132 acquires pieces using the second terminal 130 during a preparation phase and a selection phase of a battle, and arranges the pieces in a battle area of a board during a preparation phase of the battle. The second terminal 130 or the server 120 automatically controls the pieces to battle during the battle phase according to attributes, skills, and arrangement of the pieces in the battle area.

In one embodiment, the pieces arranged by the first user 112 via the first terminal 110 and those arranged by the second user 132 via the second terminal 130 are located in different battle areas on the same board. To be specific, the first user 112 and the second user 132 are in the same board within the same battle. Alternatively, the pieces arranged by the first user 112 via the first terminal 110 and those arranged by the second user 132 via the second terminal 130 are located on different boards. To be specific, the first user 112 and the second user 132 are in different boards within the same battle. In an embodiment, a single battle of the turn-based board game involves eight user accounts. In each turn, the eight user accounts are paired up, and the two user accounts that are paired together engage in a battle on the same board during this turn.

In one embodiment, the clients installed on the first terminal 110 and the second terminal 130 are the same, or the clients installed on the two terminals are the same type of clients on different operating system platforms. The first terminal 110 may refer to one of a plurality of terminals, and the second terminal 130 may refer to another one of the plurality of terminals. In an embodiment, the first terminal 110 and the second terminal 130 are introduced as a non-limiting example for description. The first terminal 110 and the second terminal 130 are of the same or different device types, including at least one of a smartphone, a tablet computer, an e-book reader, a laptop computer, or a desktop computer. In the following embodiments, an example in which the terminal includes a smartphone is used for description.

In some examples, a computer-implemented interactive environment (e.g., a game) may be performed by more or fewer terminals than the first terminal 110 and the second terminal 130. For example, there may be one above-mentioned terminal (i.e., the user battles against artificial intelligence), or there may be 6 or 8 or more terminals. The number of terminals and the device types are not limited in this disclosure.

Two terminals are shown in FIG. 1. However, in different embodiments, there may be a plurality of other terminals 140 that can access the server 120. In one embodiment, there are one or more terminals 140 that correspond to a developer. A development and editing platform for a client that supports a virtual environment is installed on the terminal 140. The developer may edit and update the client on the terminal 140, and transmit an updated client installation package to the server 120 over a wired or wireless network. The first terminal 110 and the second terminal 130 may download the client installation package from the server 120 to update the client.

The first terminal 110, the second terminal 130, and the other terminals 140 are connected to the server 120 via a wireless network or a wired network.

The server 120 is implemented as at least one of one server, a plurality of servers, a cloud computing platform, and a virtualization center. The server 120 is configured to provide a background service for a client supporting a virtual environment (a client of a turn-based board game/a client of an auto chess game). In one embodiment, the server 120 undertakes main computing work, and the terminal undertakes secondary computing work. Alternatively, the server 120 undertakes the secondary computing work, and the terminal undertakes the main computing work. Alternatively, the server 120 and the terminal perform collaborative computing by using a distributed computing architecture.

In an embodiment, the server 120 includes a processor 122, a user account database 123, a battle service module 124, and a user-oriented input/output (I/O) interface 125. The processor 122 is configured to load instructions stored on the server 120, and process data in the user account database 123 and the battle service module 124. The user account database 123 is configured to store data of user accounts used by the first terminal 110, the second terminal 130, and the other terminals 140, such as avatars of the user accounts, nicknames of the user accounts, fighting power indexes of the user accounts, and service areas of the user accounts. The battle service module 124 is configured to provide a plurality of battle rooms for users to battle. The user-oriented I/O interface 125 is configured to establish communication with the first terminal 110 and/or the second terminal 130 via a wireless network or a wired network for data exchange.

In an embodiment of this disclosure, taking the first terminal 110 acquiring a piece during a selection turn as an example, the first terminal 110 may display a first game page. The first game page may include a plurality of piece areas in a moving state and a plurality of selectable areas in a stationary state. The number of piece areas may be equal to that of selectable areas. Each piece area may display one piece. The number of users participating in the selection turn is 8, and each user controls one virtual character. A selectable area selected is determined via a selection operation of a virtual character. Each virtual character selects one selectable area. For example, during the process of controlling virtual characters to select selectable areas, the order of the virtual characters selecting the selectable areas may be determined based on the hit points of the virtual characters. The lower the hit points of a virtual character, the earlier it may be allowed to select a selectable area. After a selectable area is selected by a virtual character, the selected selectable area may be in a locked state. In other words, the selectable area in the locked state is prevented from being selected by other virtual characters.

During the process of controlling the virtual characters to select selectable areas, a moving speed of the piece areas may decrease uniformly. When all virtual characters have completed the selection of the selectable areas, the moving speed of the piece areas decreases to 0. In this case, the piece areas are in one-to-one correspondence with the selectable areas. The pieces displayed in the piece areas are then assigned to the virtual characters that select the corresponding selectable areas, thereby completing the acquisition of the pieces.

In an embodiment of this disclosure, during the selection process of the selectable areas, the piece areas are in the moving state and may display corresponding pieces therein. This can improve the unpredictability and fun of the piece selection process, and to a certain extent, can increase the probability that a virtual character selecting a selectable area later in order obtains a desired piece. The overall gaming experience is enhanced, and the human-computer interaction efficiency is improved. In some embodiments, the selectable areas may alternatively be referred to as candidate areas.

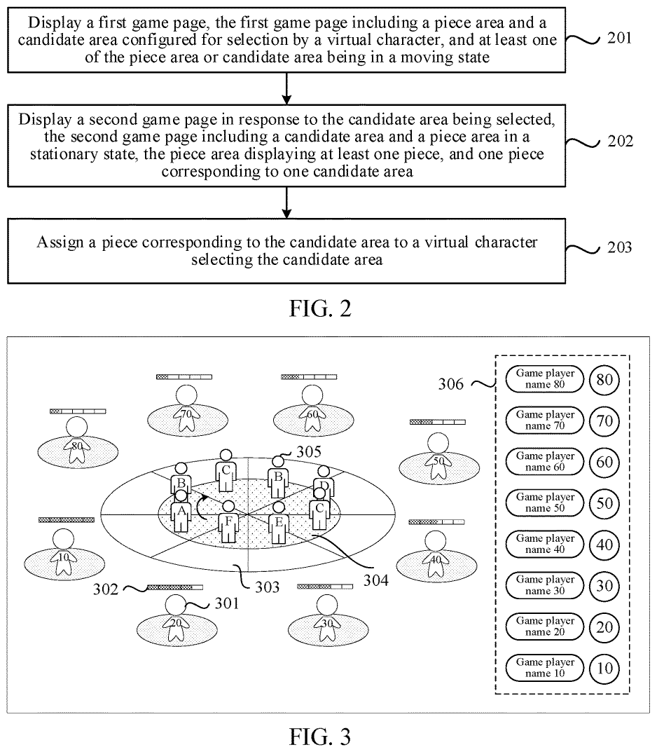

The method of piece assignment in a computer-implemented interactive environment (e.g., for a turn-based board game) provided in the embodiments of this disclosure can be applied to the computer system shown in FIG. 1. The method of piece assignment for a turn-based board game may be performed by a computer device, which may be a terminal (the first terminal 110 and the second terminal 130) in the computer system shown in FIG. 1, or may be the server 120 in the computer system shown in FIG. 1. For example, the method may be performed by the first terminal 110 and the second terminal 130 in FIG. 1, or may be performed interactively by the first terminal 110, the server 120, and the second terminal 130. Taking as an example that the method is performed by a terminal (the first terminal 110 and the second terminal 130), as shown in FIG. 2, the method includes the following operations 201 to 203.

In operation 201, a first game page is displayed. The first game page includes a piece area and a candidate area for selection by a virtual character, and at least one of the piece area or the candidate area is in a moving state. For example, a first game page of the computer-implemented interactive environment is displayed, the first game page including a plurality of piece areas and a plurality of corresponding candidate areas, the plurality of candidate areas being selectable by one or more virtual characters, and at least the plurality of piece areas or the plurality of candidate areas being in a moving state.

The first game page is a page initially presented during a selection phase of a current game turn of the turn-based board game. In other words, the first game page is a page presented when none of the virtual characters participating in the current game turn have selected a candidate area.

In some embodiments, the candidate area may alternatively be referred to as a selectable area. In other words, the first game page includes a piece area and a selectable area for selection by a virtual character, and at least one of the piece area or the selectable area is in a moving state.

In an embodiment of this disclosure, the first game page may include a plurality of piece areas. The content displayed in a piece area includes at least one of a piece or piece information. The piece information may include at least one of level information, expense information, or identification information of the piece. For example, each piece area may display at least one of a piece or piece information. In other words, a piece area may display a piece, or may display piece information, or may display both a piece and piece information. For example, a piece may be a virtual object having a particular shape, and the piece area may display the virtual object, or may display the level information of the virtual object, or may display both the virtual object and the level information of the virtual object.

The expense information of a piece is configured for indicating a piece expense, which refers to the quantity of resources to be consumed when the piece is used in the turn-based board game. The expense information of the piece may be the piece expense, or may be other information that may indicate the piece expense. This disclosure does not impose limitations on this. The level information of a piece is configured for indicating a piece level, which is a quantitative representation of the piece's ability in the turn-based board game. The level information of the piece may be the piece level, or other information that may indicate the piece level. This disclosure does not impose limitations on this. The identification information of a piece is characteristic information configured for distinguishing among different pieces, and may include, but is not limited to, the piece's name, shape, color, pattern, or faction mark.

An example in which the piece information is the piece level is used for description. The piece information is the level corresponding to the piece acquired by the user in the current game turn. Each piece may correspond to one level, and the same level may correspond to a plurality of pieces. Pieces of different levels have different attribute values. For example, pieces of different levels may differ in attack power and defense power.

An example in which the piece information is the piece expense is used for description. The piece expense may be related to the piece's rarity, attribute value, function, and acquisition difficulty. For example, the higher rarity of a piece indicates a higher attribute value or stronger function of the piece, a greater acquisition difficulty of the piece, and hence a higher piece expense corresponding to the piece.

For example, the first game page may further include a plurality of candidate areas, and the number of candidate areas may be equal to that of piece areas. In some embodiments, the number of candidate areas may alternatively differ from that of piece areas. For example, the number of candidate areas may be less than that of piece areas.

In an embodiment of this disclosure, at least one of the piece area or the candidate area is in the moving state. For example, the piece areas are in the moving state, while the candidate areas are in a stationary state. Alternatively, the piece areas are in the stationary state, while the candidate areas are in the moving state. Alternatively, both the piece areas and the candidate areas are in the moving state.

For example, the number of piece areas and the number of candidate areas are both plural. A plurality of piece areas and a plurality of candidate areas are arranged in a particular manner. The arrangement of the plurality of piece areas and the arrangement of the plurality of candidate areas may be set based on experience or flexibly adjusted according to application scenarios. This disclosure does not impose limitations on this. The plurality of piece areas and/or the plurality of candidate areas move according to their arrangement(s). For example, the arrangements of the piece areas and the candidate areas may be the same or different.

In some embodiments, the arrangement of a plurality of areas (a plurality of piece areas or a plurality of candidate areas) may include a circular arrangement, which means that the plurality of areas are arranged in a circle. For example, the circular arrangement may include a clockwise circular arrangement or a counterclockwise circular arrangement. The clockwise circular arrangement means that a plurality of areas are arranged clockwise in a circle. The counterclockwise circular arrangement means that a plurality of areas are arranged counterclockwise in a circle.

In some other embodiments, the arrangement of a plurality of areas may further include a linear arrangement, which means that the plurality of areas are arranged in a straight line. For example, the linear arrangement may include a transverse linear arrangement or a longitudinal linear arrangement. The transverse linear arrangement means that a plurality of areas are arranged transversely in a straight line. The longitudinal linear arrangement means that a plurality of areas are arranged longitudinally in a straight line.

The implementation of a plurality of areas (a plurality of piece areas or a plurality of candidate areas) moving according to their arrangement is related to the arrangement. For example, if the arrangement of a plurality of areas is a clockwise circular arrangement, the plurality of areas moving based on the arrangement may refer to that the plurality of areas circularly move clockwise as a whole. If the arrangement of a plurality of areas is an anticlockwise circular arrangement, the plurality of areas moving based on the arrangement may refer to that the plurality of areas circularly move anticlockwise as a whole. If the arrangement of a plurality of areas is a transverse linear arrangement, the plurality of areas moving based on the arrangement may refer to that the plurality of areas cyclically move from left to right as a whole, or cyclically move from right to left as a whole. If the arrangement of a plurality of areas is a longitudinal linear arrangement, the plurality of areas moving based on the arrangement may refer to that the plurality of areas cyclically move from top to bottom as a whole, or cyclically move from bottom to top as a whole.

When a plurality of piece areas are in the moving state, during the movement, the content (at least one of a piece or piece information) displayed in each piece area remains unchanged.

In one embodiment, when the arrangements of the piece areas and the candidate areas are the same, the shapes of the piece areas and the candidate areas may be determined based on the arrangement. For example, the piece areas and the candidate areas may be arranged circularly or linearly. When the piece areas and the candidate areas are arranged circularly, the overall area composed of the piece areas and the candidate areas may be in the shape of a wheel, the piece areas and candidate areas may be fan-shaped, and the piece areas may be part of the candidate areas. When the piece areas and the candidate areas are arranged linearly, the piece areas and the candidate areas may be rectangular in shape.

The arrangements and shapes of the piece areas and candidate areas described in this disclosure are illustrative. Other arrangements and shapes of the piece areas and candidate areas are also possible. This disclosure does not impose limitations on them.

In one embodiment, the first game page may further display virtual characters. A virtual character is a character controlled by a user, and may alternatively be referred to as a player or a little hero. The virtual characters may have attribute values. After the current game turn ends, the attribute values of the virtual characters may be adjusted based on the results of the current game turn. The first game page may display the attribute values of the virtual characters, or may not display the attribute values of the virtual characters. For example, the attribute value of a virtual character may be hit points of the virtual character, and the hit points corresponding to the virtual character may be displayed around the virtual character in the first game page. The display manners for hit points may include, but are not limited to, bar display, ring display, or numerical display. When different users battle in a game turn, the user who loses the turn may have a portion of the hit points of the virtual character deducted. The virtual characters displayed in the first game page refer to all virtual characters controlled by all users participating in the current piece assignment process, or may refer to all virtual characters participating in the current game turn.

In one embodiment, the first game page may further include an information display area that is configured to present at least one of user-related information or game-related information. For example, the information display area may display user names and user avatars. The information display area may alternatively display game progress information and user interaction information. In one embodiment, the game progress information may include, but is not limited to, game progress or current game turn information. The user interaction information may include, but is not limited to, interaction information between different users, game system information, game comment information, or game sharing information. The display content of the information display area described in this disclosure is illustrative, and may alternatively be set based on the actual conditions during the game. This is not limited in this disclosure.

In an embodiment of this disclosure, an example in which the piece areas display pieces and the first game page displays virtual characters and attribute values corresponding to the virtual characters is used for description. FIG. 3 is a schematic diagram of a first game page according to an embodiment of this disclosure. As shown in FIG. 3, the first game page may include 8 virtual characters 301 and the hit points 302 corresponding to the virtual characters. Different virtual characters 301 may be controlled by different users. The first game page may further include a plurality of candidate areas 303 and a plurality of piece areas 304. The number of candidate areas 303 is equal to that of piece areas 304. Each piece area 304 may display one piece 305 therein. The plurality of candidate areas 303 and the plurality of piece areas 304 are arranged in the same manner. At least the plurality of candidate areas 303 or the plurality of piece areas 304 are in a moving state, where the piece 305 displayed in each piece area 304 remains unchanged.

For example, 8 candidate areas 303 and 8 piece areas 304 are arranged circularly. The 8 piece areas 304 may contain the same piece 305. Alternatively, the 8 piece areas 304 may contain different pieces 305. Different pieces 305 may have the same piece level or different piece levels. The 8 pieces 305 include 1 piece A, 2 pieces B, 2 pieces C, 1 piece D, 1 piece E, and 1 piece F.

Taking as an example that the piece areas 304 are in the moving state and the candidate areas 303 are in a stationary state, the 8 piece areas 304 may move clockwise (the direction indicated by the arrow). During the movement of the 8 piece areas 304, the pieces 305 displayed in the piece areas 304 remain unchanged. The first game page may further include an information display area 306 that is configured to present user-related information. For example, the information display area 306 may display user names and user avatars. The user names include game player name 10, game player name 20, . . . , and game player name 80, and the user avatars may be circular avatars.

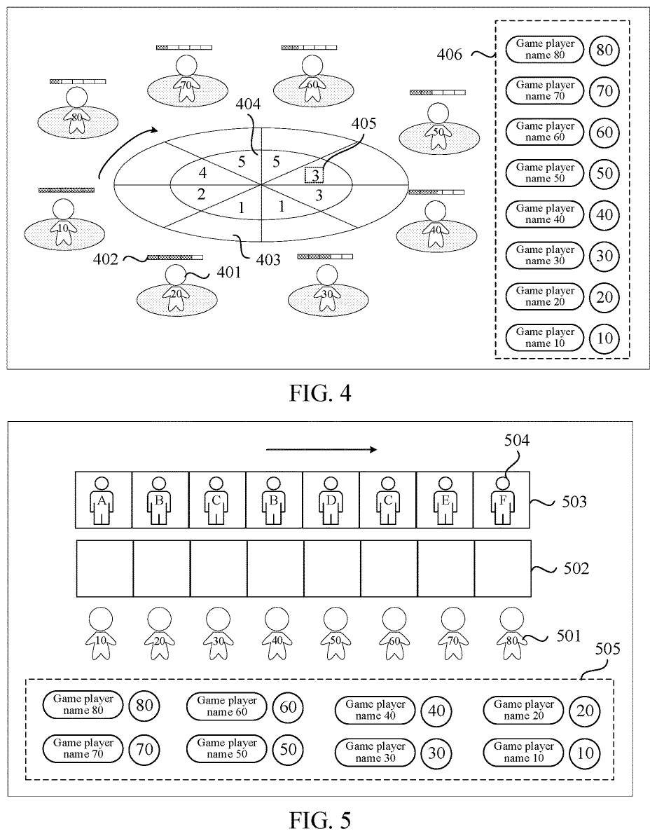

In another embodiment of this disclosure, an example in which the piece areas display piece information, i.e., piece levels, and the first game page displays virtual characters and attribute values corresponding to the virtual characters is used for description. FIG. 4 is a schematic diagram of another first game page according to an embodiment of this disclosure. As shown in FIG. 4, the first game page may include a plurality of virtual characters 401, hit points 402 corresponding to the virtual characters, a plurality of candidate areas 403, and a plurality of piece areas 404. Each piece area 404 may display the level 405 (the number in the dashed box) of a piece. The plurality of candidate areas 403 and the plurality of piece areas 404 are as many as each other, and are arranged in the same manner. At least the plurality of candidate areas 403 or the plurality of piece areas 404 are in a moving state.

For example, 8 candidate areas 403 and 8 piece areas 404 may be arranged circularly. The 8 piece areas 404 may contain the same piece level 405. Alternatively, the 8 piece areas 404 may contain different piece levels 405. The same piece level 405 may correspond to different pieces. The 8 piece levels 405 include 2 piece levels of 1, 1 piece level of 2, 2 piece levels of 3, 1 piece level of 4, and 2 piece levels of 5.

Taking as an example that the piece areas 404 are in the moving state and the candidate areas 403 are in a stationary state, the 8 piece areas 404 may move clockwise (the direction indicated by the arrow). During the movement of the 8 piece areas 404, the piece levels 405 displayed in the piece areas 404 remain unchanged. The first game page may further include an information display area 406. The virtual characters 401, the hit points 402 corresponding to the virtual characters, the plurality of candidate areas 403, and the information display area 406 are similar to the virtual characters 301, the hit points 302 corresponding to the virtual characters, the plurality of candidate areas 303, and the information display area 306 in FIG. 3, and will not be described redundantly here.

In addition to being arranged circularly, the candidate areas and the piece areas may be arranged linearly. FIG. 5 is a schematic diagram of another first game page according to an embodiment of this disclosure. As shown in FIG. 5, the first game page may include virtual characters 501, a plurality of candidate areas 502, and a plurality of piece areas 503. The number of candidate areas 502 is equal to that of piece areas 503. Each piece area 503 may display one piece 504 therein. The plurality of candidate areas 502 and the plurality of piece areas 503 are arranged linearly. At least the plurality of candidate areas 502 or the plurality of piece areas 503 are in a moving state, where the piece 504 displayed in each piece area 503 remains unchanged.

For example, the plurality of piece areas 503 are in the moving state, while the plurality of candidate areas 502 are in a stationary state. The plurality of piece areas 503 may move cyclically from left to right (the direction indicated by the arrow). During the cyclic movement of the plurality of piece areas 503, the pieces 504 displayed in the piece areas 503 remain unchanged. The first game page may further display an information display area 505. The content displayed in the first game page in FIG. 5 is similar to that displayed in the first game page in FIG. 3, and will not be described redundantly here.

Furthermore, this disclosure is described by using as an example in which the plurality of piece areas and the plurality of candidate areas are arranged circularly and linearly. The plurality of piece areas and the plurality of candidate areas may alternatively be arranged elliptically or arranged in other polygons. This is not limited in this disclosure.

In the embodiments of this disclosure, since at least one of the piece area or the candidate area is in the moving state, the first game page presents a dynamic effect, which may attract the user's attention and increase the fun during the game. This helps enhance the gaming experience and enhance the sense of immersion during the game, thereby improving the human-computer interaction efficiency.

In an embodiment of this disclosure, in the first game page, at least the piece area (e.g., the plurality of piece areas) or the candidate area (e.g., the plurality of candidate areas) moves uniformly at a reference speed. The reference speed is determined based on related information of the virtual character, where the related information of the virtual character includes at least one of a number of virtual characters, an attribute value, or a reference resource, and the number of virtual characters is less than or equal to that of candidate areas. In some examples, the related information of the one or more virtual characters includes at least one of a number of the one or more virtual characters, an attribute value of the one or more virtual characters, or a reference resource of the one or more virtual characters. In some examples, the number of the one or more virtual characters is less than or equal to a number of the plurality of candidate areas.

Determining the reference speed based on the related information of the virtual character includes, but is not limited to, Embodiments 1 to 3.

In Embodiment 1, the related information of the virtual character is the number of virtual characters, and the reference speed is determined based on the number of virtual characters.

The number of virtual characters participating in a current game turn, i.e., the number of users in the current game turn, is obtained. The number of virtual characters is positively correlated with the reference speed. To be specific, the smaller the number of virtual characters, the lower the reference speed. In an embodiment, the number of virtual characters is less than or equal to that of candidate areas so that each virtual character can select one candidate area.

After the reference speed is determined, the first game page may display the piece areas or the candidate areas moving at the reference speed. For example, the piece areas may move uniformly at the reference speed while the candidate areas have a moving speed of 0 (i.e., the candidate areas are in the stationary state). As another example, the candidate areas may move uniformly at the reference speed while the piece areas have a moving speed of 0 (i.e., the piece areas are in the stationary state). As yet another example, both the piece areas and the candidate areas move uniformly at the reference speed.

The following description is made by using as an example in which the piece areas are in the moving state while the candidate areas are in the stationary state. For example, in the current game turn, the number of virtual characters is 8, and the reference speed of the piece areas is V8. During the process of displaying the first game page, the reference speed V8 of the piece areas may remain unchanged. In the next game turn, the number of virtual characters is 6,and the reference speed of the piece areas is V6. The relationship between the reference speed V8 of the piece areas in the current game turn and the reference speed V6 of the piece areas in the next game turn may satisfy V6<V8.

This disclosure is described by using as an example in which at least one of the piece area or the candidate area in the first game page moves at a constant speed. In the first game page, the moving speed of at least one of the piece area or the candidate area may decrease progressively. The moving speed of at least one of the piece area or the candidate area may be set based on actual game conditions, and will not be limited in this disclosure.

In the embodiments of this disclosure, the moving speed of at least one of the piece area or the candidate area is determined based on the number of virtual characters. A larger number of virtual characters corresponds to a higher moving speed, while a smaller number of virtual characters corresponds to a lower moving speed. The game process can be dynamically controlled, and the human-computer interaction efficiency can be improved, thereby enhancing resource utilization. Moreover, when the number of virtual characters is small, the smoothness of the game page display can be improved to a certain extent by reducing the moving speed of at least one of the piece area or the candidate area.

In Embodiment 2, the related information of the virtual character refers to the attribute values of the virtual character, and the reference speed is determined based on the attribute value of the virtual character.

In an embodiment of this disclosure, the reference speed of at least one of the piece area or the candidate area is determined based on the attribute values of the virtual characters. The attribute values of virtual characters in the current game turn are obtained. The attribute values of the virtual characters may include hit points of the virtual characters.

In some embodiments, the implementation of determining the reference speed based on the attribute value of the virtual character includes: obtaining the attribute value of the virtual character controlled by the current terminal, and using a speed that is positively correlated with the attribute value as the reference speed corresponding to the current terminal. The reference speed corresponding to the current terminal is the reference speed at which at least one of the piece area or the candidate area in the first game page displayed by the current terminal moves uniformly.

Taking as an example that the attribute value of the virtual character refers to the hit points of the virtual characters, different users may control virtual characters using different terminals. The hit points of the virtual character are positively correlated with the reference speed. To be specific, the lower the hit points of the virtual character, the lower the reference speed. For example, if the hit points of the virtual character controlled by user 10 are lower than the hit points of the virtual character controlled by user 20, the moving speed of at least one of the piece area or the candidate area in the first game page displayed on the terminal of user 10 is lower than that in the first game page displayed on the terminal of user 20.

The attribute value of the virtual character in the embodiments of this disclosure is illustrative. The attribute value of the virtual character may alternatively be other attribute values, which will not be limited in this disclosure.

In an embodiment of this disclosure, the reference speed is determined based on the attribute value of the virtual character, and at least one of the piece area or the candidate area moves uniformly at the reference speed. Thus, a diversified and personalized first game page is provided. For example, a user can change the reference speed by controlling the hit points of the virtual character, so that the efficiency of selecting candidate areas in subsequent game process can be improved, thereby increasing the chance of obtaining desired pieces and increasing the strategic nature and the diversity of the game process.

In some other embodiments, the implementation of determining the reference speed based on the attribute value of the virtual character includes: obtaining an average attribute value among the attribute values of the virtual characters in the current game turn; and using a speed that is positively correlated with the average attribute value as a reference speed corresponding to a current terminal. In this case, in the first game pages displayed on the terminals of all users controlling the virtual characters in the current game turn, at least one of the piece area or the candidate area moves uniformly at the same reference speed.

In Embodiment 3, the related information of the virtual character refers to the reference resource of the virtual character, and the reference speed is determined based on the reference resource of the virtual character.

In an embodiment of this disclosure, the reference resource is a resource acquired by a virtual character during the game. After a virtual character uses the reference resource, the reference resource possessed by the virtual character will be reduced. The reference resource may include, but is not limited to, energy or a special rune. Energy is a resource configured to limit and drive various behaviors and skills of the virtual character. Rune is a resource with a specific function and attribute. The special rune mentioned here is a rune that has the specific function of reducing the moving speed.

Determining the reference speed based on the reference resource of the virtual character includes case 1 or case 2.

In case 1, the reference speed is determined based on the energy used by the virtual character.

For example, the implementation of determining the reference speed based on the energy used by the virtual character includes: determining the energy used by the virtual character controlled by the current terminal; determining a first reduction magnitude based on the energy used by the virtual character controlled by the current terminal; and reducing an initial speed by the first reduction magnitude to obtain the reference speed. The first reduction magnitude is positively correlated with the energy used by the virtual character controlled by the current terminal. The initial speed is a default uniform moving speed. The initial speed may be set based on experience or flexibly adjusted according to application scenarios. This is not limited in the embodiments of this disclosure.

The following description is made by using as an example in which the reference speed is the moving speed of the piece area. In the first game page, the piece area moves uniformly at a default initial speed. The user can reduce the moving speed of the piece area by using energy, thereby decreasing the moving speed of the piece area. The energy used is positively correlated with the reduction magnitude of the moving speed of the piece area. To be specific, the more energy used, the greater the reduction magnitude of the moving speed of the piece area.

For example, the energy may be diamonds possessed by the virtual character. The user may use 2 diamonds to reduce the moving speed by 10%. Alternatively, the user may use 4 diamonds to reduce the moving speed by 20%.

In case 2, the reference speed is determined based on the special rune used by the virtual character. The special rune is configured for reducing the moving speed.

For example, the implementation of determining the reference speed based on the special rune used by the virtual character includes: determining a second reduction magnitude corresponding to the special rune used by the virtual character controlled by the current terminal; and reducing an initial speed by the second reduction magnitude to obtain the reference speed. The second reduction magnitude corresponding to the special rune is related to the type of the special rune. This is not limited in the embodiments of this disclosure.

The following description is made by using as an example in which the reference speed is the moving speed of the piece area. In the first game page, the piece area moves uniformly at a default initial speed. The user may reduce the moving speed of the piece area by using the special rune. In other words, after the special rune is used, the moving speed of the piece area in the first game page can be reduced. For example, the moving speed may be reduced by 10% by using the special rune.

In an embodiment of this disclosure, the reference speed is determined based on the reference resource of the virtual character. Thus, a diversified and personalized first game page is provided. For example, the user can change the reference speed by using at least one of the special rune and the energy used, so that the efficiency of selecting candidate areas in subsequent game process can be improved, thereby increasing the chance of obtaining desired pieces and increasing the strategic nature and the diversity of the game process.

The approach of determining the reference speed described in this disclosure is illustrative. Other approaches of determining the reference speed are also possible. This is not limited in this disclosure.

In some embodiments, the related information of the virtual character includes at least two of the number of virtual characters, the attribute value, or the reference resource. In this case, the implementation of determining the reference speed based on the related information of the virtual character may include: determining a moving speed based on each piece of information included in the related information of the virtual character, and then taking an average value or a weighted value of the determined moving speeds as the reference speed. Each piece of information included in the related information of the virtual character may be the number of virtual characters, the attribute value of the virtual character, or the reference resource of the virtual character. The moving speed determined based on the number of virtual characters is the reference speed determined based on the number of virtual characters in Embodiment 1 hereinabove. The moving speed determined based on the attribute value of the virtual character is the reference speed determined based on the attribute value of the virtual character in Embodiment 2 hereinabove. The moving speed determined based on the reference resource of the virtual character is the reference speed determined based on the reference resource of the virtual character in Embodiment 3 hereinabove.

Before displaying the first game page, a content displayed in the piece area may be determined. The process of determining the content displayed in the piece area may include: displaying a voting page, the voting page being configured to vote on the content displayed in the piece area; and determining, based on a voting result of the voting page, the content displayed in the piece area.

The voting page may include a content display control. For example, the content display control may include a piece display control, a piece information display control, and an all display control. When a trigger operation is received on the piece display control, the piece information display control, or the all display control, corresponding voting information may be generated. The voting result is determined using the voting information from each user. The voting result may include the number of votes for the piece display control, the number of votes for the piece information display control, and the number of votes for the all display control. The content corresponding to the content display control with a greater number of votes in the voting result is used as the final content displayed in the piece area. After determining the content displayed in the piece area, the first game page may be generated based on the content displayed in the piece area.

In the embodiments of this disclosure, by using the voting page to select the content displayed in the piece area based on game player's own preferences and needs, the content displayed in the piece area can meet the needs of the majority of game players in the current game turn, thereby enhancing the personalized experience and sense of participation for game players. Thus, the gaming experience is enhanced, and the human-computer interaction efficiency is improved.

In an embodiment of this disclosure, before displaying the first game page, a faction selection page may be displayed. The faction selection page may be configured to determine a faction to which a virtual character belongs. In one embodiment, the process of determining the faction to which the virtual character belongs via the faction selection page may include: displaying the faction selection page, the faction selection page including a plurality of factions and a plurality of reference areas, and at least the plurality of factions or the plurality of reference areas are in a moving state; and displaying a faction selection result page when all virtual characters have selected reference areas, the faction selection result page including the plurality of reference areas and the plurality of factions in a stationary state, one faction corresponding to one reference area, the faction corresponding to the one reference area being the faction to which a reference number of virtual characters that have selected the one reference area belong, and the reference number being less than or equal to a second number threshold.

For example, a faction is a classification attribute indicating that virtual characters belong to the same group in the game. For example, each faction may include a plurality of virtual characters. Factions may include, but are not limited to: Great Wall, Three Kingdoms (Wei, Shu, Wu), Xuanyong, Mech, Yaotian, or Chang'an. Factions may be configured to adjust the attribute values of the pieces possessed by virtual characters. Different factions may adjust different attribute values of pieces. To be specific, different factions may have different synergy effects on virtual characters, where the synergy effects may include, but are not limited to, increasing the attack power of pieces, increasing the defense power of pieces, or increasing the hit points of pieces.

In one embodiment, the number of factions is the same as that of reference areas. The number of virtual characters may be greater than, equal to, or less than that of reference areas. In one embodiment, the virtual characters refer to all virtual characters currently participating in the turn-based board game. The number of virtual characters, the number of reference areas, and the number of factions may be set based on actual conditions during the game. This is not limited in this disclosure.

The factions are arranged in a particular manner in the faction selection page, and at least the factions or the reference areas are in the moving state. During movement, at least the factions or the reference areas may move at a constant speed or decelerate. The following description is made by using as an example in which the factions are in the moving state while the reference areas are in the stationary state. When a moving duration of the factions reaches a specified duration, the factions stop moving. Alternatively, when the factions decelerate and the moving speed of the factions decreases to 0, the factions stop moving. Alternatively, when all virtual characters have selected reference areas, the factions stop moving.

During the movement of at least the factions or the reference areas, users can control their virtual characters to select reference areas. A reference area may be selected by one or more virtual characters. This disclosure does not limit the manner of the virtual character selecting a reference area. For example, the manner of the virtual character selecting a reference area may refer to the virtual character moving into the reference area, or may refer to the user controlling the virtual character triggering (e.g., by clicking/tapping, double-clicking/tapping, long-pressing, etc.) the reference area. When a selection operation on a reference area is received, a virtual character that selects the reference area is determined. When the number of virtual characters that select the reference area is greater than or equal to a second number threshold, the reference area is prevented from being selected by other virtual characters. The second number threshold is a maximum number of virtual characters selecting the same reference area. The second number threshold may be set based on experience or flexibly adjusted according to application scenarios. This is not limited in the embodiments of this disclosure. After at least the factions or the reference areas stop moving, the reference areas are in one-to-one correspondence with the factions, and the faction corresponding to a reference area is the faction to which the virtual characters that have selected the reference area belong.

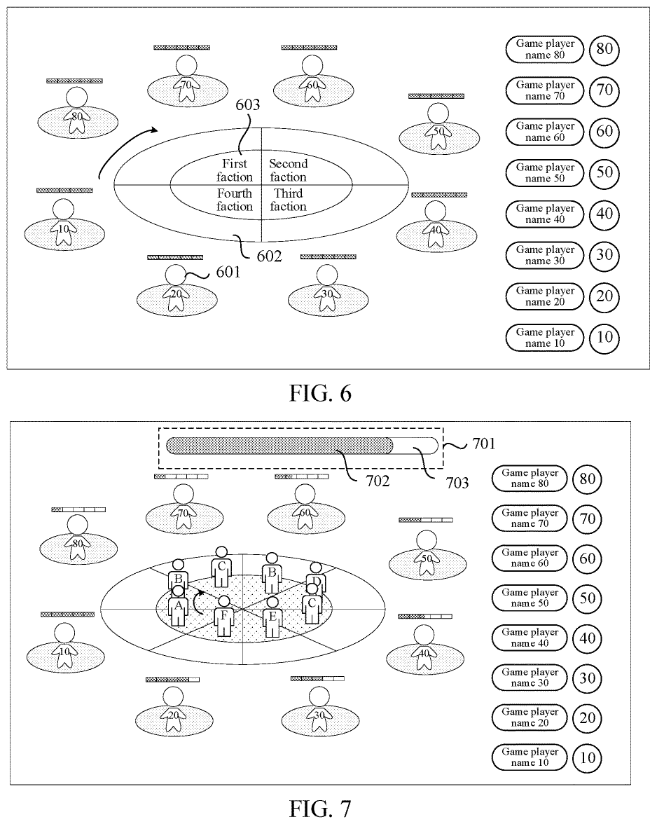

This embodiment of this disclosure is described by using as an example in which the factions are in the moving state while the reference areas are in the stationary state. FIG. 6 is a schematic diagram of a faction selection page according to an embodiment of this disclosure. As shown in FIG. 6, the faction selection page includes virtual characters 601, reference areas 602, and factions 603. The factions 603 include a first faction, a second faction, a third faction, and a fourth faction. The factions 603 move clockwise (the direction indicated by the arrow). Each reference area 602 may be selected by 2 virtual characters 601. During the movement of the factions 603, the virtual characters 601 are unlocked. After being unlocked, the virtual characters 601 can move in the faction selection page and select a reference area 602. When a virtual character completes the selection of the reference area 602, the reference area 602 becomes associated with the virtual character 601. After the factions 603 stop moving, the reference areas 602 are in one-to-one correspondence with the factions 603. The faction 603 corresponding to the reference area 602 is the faction 603 to which the virtual character 601 associated with the reference area 602 belongs.

In the embodiments of this disclosure, by selecting the faction to which a virtual character belongs via the faction selection page, users need to observe the movement pattern of the factions or the reference areas and choose the corresponding faction. This increases the uncertainty of faction selection during the game, thereby enhancing the fun and gaming experience. Thus, the human-computer interaction efficiency is improved.

In operation 202, a second game page is displayed in response to a candidate area being selected, the second game page including a candidate area and a piece area in a stationary state, the piece area displaying at least one piece, and one piece corresponding to one candidate area. In some examples, whether a number of selected candidate areas of the plurality of candidate areas selected by the one or more virtual characters reaches a reference number is determined. In some examples, a second game page of the computer-implemented interactive environment is displayed when the number of the selected candidate areas is determined to reach the reference number, the second game page including the plurality of candidate areas and the plurality of piece areas in a stationary state, each one of the plurality of piece areas displaying a respective piece and corresponding to a respective one of the plurality of candidate areas. In some examples, the reference number is a number of the one or more virtual characters.

In some embodiments, the candidate area may alternatively be referred to as a selectable area. In other words, the second game page is displayed in response to a selectable area being selected, the second game page including a selectable area and a piece area in a stationary state, the piece area displaying at least one piece, and one piece corresponding to one selectable area.

In an embodiment of this disclosure, virtual characters may select candidate areas, where each virtual character may select one candidate area. Each candidate area may be selected by one or more virtual characters. In some embodiments, each candidate area can be selected by one virtual character. After being selected by a virtual character, a candidate area is in a locked state. To be specific, the selected candidate area is prevented from being selected by other virtual characters.

In some embodiments, the candidate area being selected may include a second number of candidate areas being selected, the second number being not greater than a first number, and the first number being the number of virtual characters. The second number may be set based on experience or flexibly adjusted according to application scenarios. This is not limited in the embodiments of this disclosure. For example, the second number may be one. In other words, the second game page is displayed in response to any candidate area being selected.

For example, the second number may be equal to the first number. In other words, the second game page is displayed in response to the first number of candidate areas being displayed. For the case where each candidate area can be selected by one virtual character, the first number of candidate areas being displayed indicates that all virtual characters have completed the selection of candidate areas. In other words, the second game page is displayed when all virtual characters have completed the selection of candidate areas. When a plurality of candidate areas are selected, the second game page is displayed if the number of selected candidate areas is equal to the number of virtual characters.

The second game page may include a plurality of candidate areas and a plurality of piece areas. Both the candidate areas and the piece areas are in the stationary state, and each candidate area is in one-to-one correspondence with each piece area.

Before displaying the second game page, a selection page may be displayed. The selection page is configured to display a picture of the virtual character selecting the candidate area. The selection page includes at least one selected candidate area that is determined based on a selection operation performed by a virtual character in an unlocked state. In one embodiment, the virtual character in the unlocked state is the virtual character unlocked based on a selection order, and the selection order is determined based on at least one of the attribute value or the reference resource of the virtual character.

In some examples, a selection page is displayed. The selection page is configured to indicate whether each of the plurality of the candidate areas is selectable, and the selection page enabling one of the one or more virtual characters that is in an unlocked state to perform a selection operation on one or more of the plurality of candidate areas indicated as selectable. In some examples, each one of the one or more virtual characters is set in the unlocked state based on a selection order, the selection order being determined based on at least one of an attribute value or a reference resource of the respective virtual character. In some examples, the selection page is further configured to display time information configured to assist the one or more virtual characters in selecting respective one or more of the plurality of candidate areas. In some examples, the selection page further includes notification information indicating whether a candidate area has been selected. In some examples, the selection page is configured to display a selected candidate area and an unselected candidate area in different manners. In some examples, in the selection page, a moving speed of at least the plurality of piece areas or the plurality of candidate areas is determined based on reference information, the reference information including at least one of the number of selected candidate areas or a game duration.

In an embodiment of this disclosure, the selection page may include a plurality of candidate areas and a plurality of piece areas. The piece areas may display corresponding pieces and/or piece information. At least the piece areas or the candidate areas are in the moving state. The selection page may further include a plurality of virtual characters. The number of virtual characters is less than or equal to that of candidate areas, and the virtual characters are configured to select candidate areas. The following description is made by using as an example in which the piece areas are in the moving state while the candidate areas are in the stationary state.

When a candidate area is selected by a virtual character, the candidate area is associated with the virtual character. In this case, the selected candidate area is in the locked state. For example, the selection page may include a plurality of virtual characters. A user controls a virtual character to select a candidate area. After the virtual character selects the candidate area, the corresponding virtual character is displayed in the candidate area.

For example, during the process of controlling the virtual character to select the candidate area, the selection order is determined based on at least one of the attribute value or the reference resource of the virtual character. The selection order may be the order in which virtual characters are unlocked. Virtual characters are unlocked sequentially according to the selection order, and virtual characters in the unlocked state can perform selection operations on candidate areas.

In an embodiment of this disclosure, at least one of the attribute value or the reference resource of each virtual character in the current game turn may be obtained. The attribute value of a virtual character may include the hit points of the virtual character. The reference resource may be energy possessed by the virtual character in the current game turn or an order adjustment rune. The order adjustment rune is a rune that has the specific function of adjusting the selection order.

Determining the selection order based on at least one of the attribute value or the reference resource may include, but is not limited to, the following cases 3 to 5.

In case 3, the selection order is based on the attribute value of the virtual character.

For example, the attribute value of the virtual character is positively correlated with a serial number of the virtual character in the selection order. To be specific, the smaller the attribute value of a virtual character, the smaller the serial number of the virtual character in the selection order. The serial number of a virtual character in the selection order indicates the position of the virtual character in the selection order. The smaller the serial number of a virtual character in the selection order, the earlier the virtual character is selected in the selection order. The earlier a virtual character is selected in the selection order, the higher the unlocking priority of the virtual character.

For example, the attribute value of a virtual character includes the hit points of the virtual characters. With reference to FIG. 3, the area around a virtual character 301 may display the hit points 302 corresponding to the virtual character. The selection order may be obtained by ordering based on the hit points 302 corresponding to the virtual characters. A virtual character with fewer hit points corresponds to a smaller serial number and is selected earlier in the selection order. In other words, virtual characters with fewer hit points may be unlocked first, and the unlocked virtual characters may select candidate areas. For example, the virtual characters may be arranged by their corresponding hit points 302 in ascending order, resulting in an unlocking order of virtual characters 301: virtual character 80, virtual character 70, virtual character 60, virtual character 50, virtual character 40, virtual character 30, virtual character 20, and virtual character 10.

In one embodiment, the selection order may be determined based on the reference resource used by a user in the current turn. For example, the reference resource used by the user in the current game turn is negatively correlated with the serial number of the virtual character controlled by the user in the selection order. In other words, the reference resource used by the user in the current game turn is positively correlated with the position of the virtual character controlled by the user in the selection order. To be specific, the more reference resources the user uses during the current game turn, the smaller the serial number of the virtual character controlled by the user in the selection order, and the earlier the virtual character controlled by the user is selected in the selection order

In case 4, the reference resource of the virtual character is the energy of the virtual character in the current game turn, and the selection order is determined based on the energy of the virtual character in the current game turn.

In an embodiment, the selection order may be determined via energy auction. During the selection order auction, users may choose the amount of energy to bid. After the auction ends, the selection order is obtained by comparing the bid energy amounts of the users. The more energy used in the auction, the smaller the serial number of the virtual character in the selection order, and the earlier it is selected in the selection order.

In another embodiment, the energy required to change the selection order may be set, where moving up one position costs a corresponding amount of energy. For example, spending 2 points of energy allows a virtual character to move up one position. If the current serial number of virtual character 10 in the selection order is 3, virtual character 10 may spend 2 points of energy to adjust the serial number of virtual character 10 in the selection order to 2.

In case 5, the reference resource of the virtual character is an order adjustment rune possessed by the virtual character, and the selection order is determined based on the order adjustment rune possessed by the virtual character.

For example, an order adjustment rune may be obtained during the game. The order adjustment rune grants a virtual character the right to select a candidate area with priority. When a use operation on an order adjustment rune is detected, the serial number of the virtual character that uses the order adjustment rune in the selection order is set to 1. In other words, the virtual character that uses the order adjustment rune may be unlocked first. The unlocking order of the remaining virtual characters may be determined based on the hit points of the virtual characters or the energy used in the current game turn, thereby obtaining the selection order (i.e., the unlocking order) of the virtual characters. Alternatively, a first selection order of the virtual characters is determined based on the hit points or reference resources of the virtual characters. When a use operation on an order adjustment rune is detected, the position of a virtual character is adjusted based on the use operation on the order adjustment rune to obtain a second selection order, which is then used as the final selection order.

In the embodiments of this disclosure, the selection order (i.e., the unlocking order of virtual characters) is determined by the hit points of the virtual characters, the energy used by the virtual characters in the current game turn, or the use of order adjustment runes by the virtual characters. This requires a user to consider more dimensions when formulating a game strategy, thereby increasing the depth and strategic nature of the game compared to related technologies that use the hit points of virtual characters to determine the selection order. On the other hand, determining the selection order based on a plurality of factors can, to a certain extent, help prevent a virtual character with lower hit points from consistently occupying a favorable selection order in a game turn, thereby improving the fairness and fun of the game. Thus, the overall gaming experience is improved.

In an embodiment of this disclosure, the selection page may further display time information. The time information is configured for assisting the virtual character in selecting the candidate area. For example, the time information may represent the time during the current game turn. Users need to control virtual characters to select candidate areas within a specified time.

The display manners for the time information may include, but are not limited to, progress bar display or countdown display. The time information is configured for indicating a remaining duration (also referred to as remaining time) for selecting a candidate area. When the display manners for the time information include the progress bar display, the entire progress bar may represent a total duration for selecting a candidate area. The entire progress bar may be divided into two parts: one representing a spent duration (also referred to as spent time) for selecting a candidate area, and the other part representing the remaining duration (also referred to as remaining time) for selecting a candidate area. When the display manners for the time information include countdown display, the numerical value in the countdown is a remaining duration for selecting a candidate area.

In some embodiments, the time information is associated with the moving areas (piece areas and/or candidate areas). For example, the remaining duration for selecting a candidate area indicated by the time information is positively correlated with the moving speed of the moving areas. To be specific, as the remaining duration for selecting a candidate area indicated by the time information continuously decreases, the moving speed of the moving areas also continuously decreases. For example, when the duration indicated by the time information is 0, the moving speed of the moving areas decreases to 0.

FIG. 7 is a schematic diagram of a selection page including time information according to an embodiment of this disclosure. As shown in FIG. 7, a time progress bar 701 is displayed in the selection page. The entire time progress bar 701 may represent the total time of a selection phase in the current game turn. The time progress bar 701 may include the spent time 703 (shown in blank) and the remaining time 702 (shown in shaded area) of the selection phase in the current game turn. Users may select candidate areas based on the time progress bar 701 and the moving state of piece areas and/or candidate areas.

Although this disclosure is described by using the example in which the selection page includes a time progress bar, the selection page may alternatively include a plurality of time progress bars. The time progress bars may be in one-to-one correspondence with virtual characters. For example, the time progress bar corresponding to a virtual character is displayed in the area around the virtual character. This disclosure does not limit the display manner of the time progress bars. The remaining durations for selecting candidate areas indicated by the time progress bars corresponding to different virtual characters may be the same or different. The area around a virtual character may include, but is not limited to, above, below, on the left of, or on the right of the virtual character.

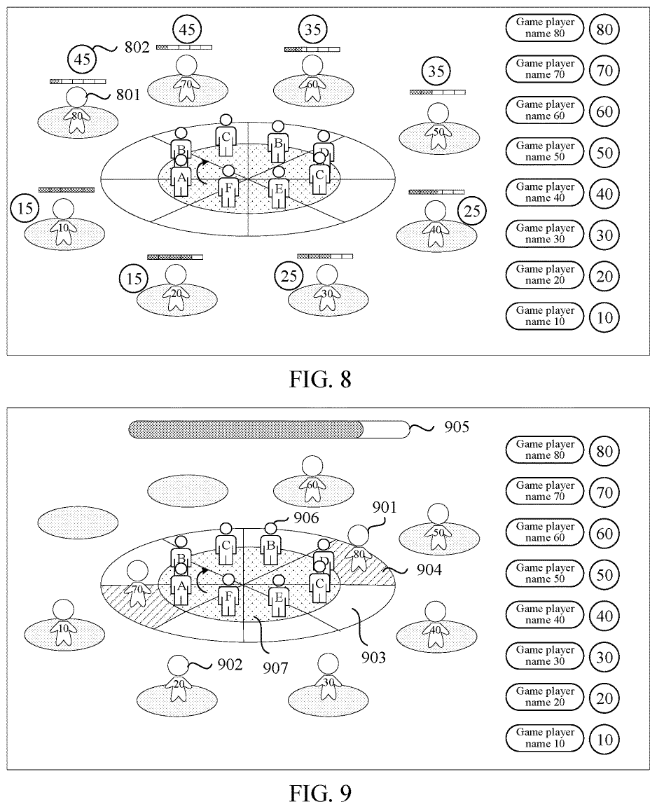

In some embodiments, a countdown corresponding to each virtual character is displayed in the area around the virtual character. The countdowns for different virtual characters may be the same or different. FIG. 8 is a schematic diagram of another selection page including time information according to an embodiment of this disclosure. As shown in FIG. 8, a countdown 802 may be displayed in the area around a virtual character 801 in the selection page. The countdown 802 may represent the time within which the virtual character 801 can select a candidate area. The countdowns 802 are in one-to-one correspondence with the virtual characters 801. Different virtual characters may correspond to the same or different initial countdown times. Users may select candidate areas based on the countdowns 802 and the moving state of piece areas and/or candidate areas. During the process of a virtual character 801 selecting a candidate area, the countdown 802 may be started. For example, the countdown for virtual character 80 is 45 seconds, while the countdown for virtual character 20 is 15 seconds.

In the embodiments of this disclosure, by displaying the time information in the selection page, users may promptly know the current game progress and remaining time, which helps users formulate and adjust game strategies, control the game rhythm, and enhance the competitiveness and diversity during the game.

In an embodiment of this disclosure, after a selection order is determined, corresponding virtual characters are unlocked based on the selection order. After the virtual characters are unlocked, the users can control the virtual characters to select candidate areas. The process of determining candidate areas based on the selection order may include:
unlocking a first virtual character based on the selection order, a serial number of the first virtual character in the selection order being smaller than or equal to a first serial number threshold; displaying the selection page in response to a first selection operation on a candidate area, the first selection operation being a selection operation performed by the first virtual character on the candidate area; unlocking a second virtual character based on the selection order when a first selection duration exceeds a first duration threshold, a serial number of the second virtual character in the selection order being larger than the first serial number threshold and smaller than or equal to a second serial number threshold; and displaying the selection page based on a second selection operation on a candidate area, the second selection operation being a selection operation on a candidate area performed by at least one of remaining first virtual characters or the second virtual character, and the remaining first virtual characters being first virtual characters that have not selected a candidate area within the first duration threshold. The first selection duration is the duration during which the first virtual character selects the candidate area. The first serial number threshold, the second serial number threshold, and the first duration threshold may be set based on experience or flexibly adjusted according to application scenarios. This is not limited in the embodiments of this disclosure.

For example, a serial number may be assigned to each virtual character based on the selection order. For example, the smaller the serial number of a virtual character, the earlier it is unlocked. During the candidate area selection process, a plurality of rounds may be included, and virtual characters corresponding to different serial numbers are unlocked based on the selection order in different rounds. In each round, at least one virtual character may be unlocked until all virtual characters in the current turn are unlocked. The numbers of virtual characters unlocked in different rounds may be the same or different.

The first virtual character is unlocked based on the selection order, and the serial number of the first virtual character in the selection order is smaller than or equal to the first serial number threshold. Taking the first virtual character as a virtual character unlocked in the first round as an example, after the first virtual character is unlocked, the first virtual character may perform the first selection operation. A selected candidate area may be determined based on the first selection operation of the first virtual character, and the selection page is displayed based on the selected candidate area.

For example, the first selection duration during which the first virtual character selects a candidate area in the first round is less than or equal to the first duration threshold. In other words, no other virtual characters will be unlocked within the first duration threshold, and the first virtual character is in an unlocked state in the selection page. If the first virtual character selects a candidate area, the selected candidate area may be determined based on the first selection operation of the first virtual character. If the first virtual character does not select a candidate area and the first selection duration exceeds the first duration threshold, the second virtual character is unlocked in the next round (the second round). The serial number of the second virtual character in the selection order is larger than the first serial number threshold and less than or equal to the second serial number threshold. In the selection page, the first virtual characters that have not selected a candidate area in the first round and the second virtual character unlocked in the second round jointly select candidate areas.

In one embodiment, the selection operations of the first virtual character and the second virtual character include, but are not limited to, controlling the virtual character to occupy a candidate area, a single-click/tap operation on a candidate area, a double-click/tap operation on a candidate area, or a long-press operation on a candidate area.

In an embodiment of this disclosure, after a virtual character selects a candidate area, the display manner of the selected candidate area is different from that of an unselected candidate area. For example, after a candidate area is selected by a virtual character, the selected candidate area may be highlighted, shaded, patterned, etc. In one embodiment, a selected candidate area may further display at least one of the corresponding virtual character or a user name, to indicate the information of the user selecting the candidate area. In some embodiments, a selected candidate area may alternatively be referred to as a chosen candidate area, and an unselected candidate area may alternatively be referred to as an unchosen candidate area.

For example, notification information may further be displayed in the selection page in response to receiving a selection operation on a selected candidate area, where the notification information is configured for prompting that the candidate area has been selected. For example, if a candidate area is selected by virtual character 70 and is in a locked state, when the candidate area in the locked state is selected by another virtual character, the selection page may display the notification information: “This area has been selected by virtual character 70. You need to choose another candidate area.”

In the embodiments of this disclosure, by displaying the notification information in the selection page to prompt that the current area has been selected, the selection state of the candidate area can be promptly fed back, guiding the user to readjust the game strategy. Thus, the interactivity and gaming experience of the game are enhanced.

The following description is made by using an example in which the current game turn involves 8 virtual characters, with 2 virtual characters being unlocked in each round and a selected candidate area displaying the virtual character. FIG. 9 is a schematic diagram of a selection page after a first round ends according to an embodiment of this disclosure. As shown in FIG. 9, in the selection page, pieces 906 may be displayed in piece areas 907. The piece areas 907 move clockwise (the direction indicated by the arrow). A first virtual character 901 is determined according to a selection order. After the first virtual character 901 is unlocked, the user can observe the time progress bar 905 and the moving state of the piece areas 907 to predict the piece area 907 corresponding to a candidate area 903, and then control the first virtual character 901 to select the candidate area 903. After the first virtual character 901 selects the candidate area 903, a selected candidate area 904 is determined based on the selection result of the first virtual character 901. The display manner of the selected candidate area 904 may be different from that of the unselected candidate areas 903. In the selection page of FIG. 9, in addition to displaying the unlocked first virtual character 901, virtual characters 902 that are still unlocked are also displayed.

For example, virtual characters unlocked in the first round based on the selection order include first virtual character 80 and first virtual character 70. The selected candidate areas 904 may display the first virtual character 80 and the first virtual character 70 that have selected the areas.

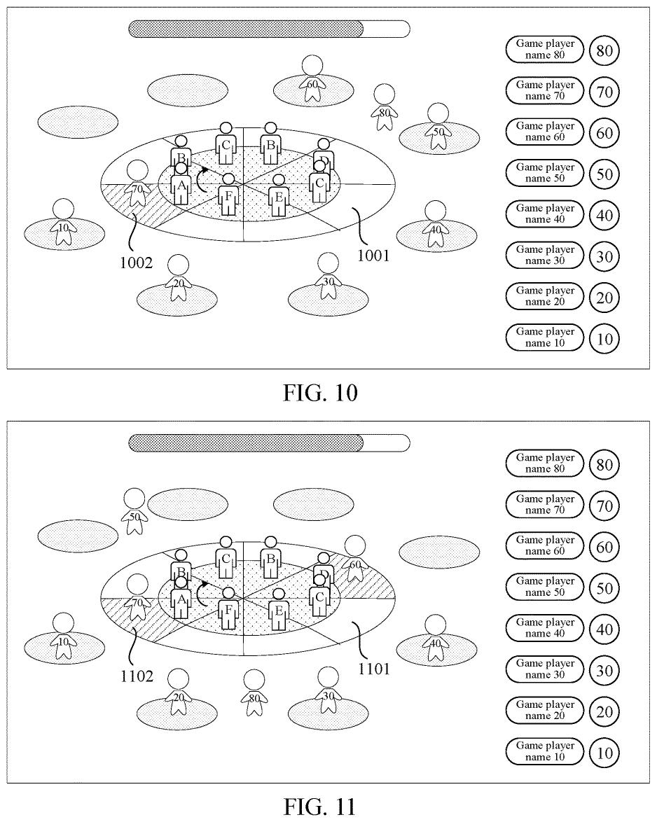

FIG. 10 is a schematic diagram of another selection page after a first round ends according to an embodiment of this disclosure. As shown in FIG. 10, the selection page may include a plurality of candidate areas 1001. First virtual character 80 and first virtual character 70 are unlocked in the first round based on the selection order. Within a first duration threshold, a selection operation of the first virtual character 70 is received, and a selected candidate area 1002 may display first virtual character 70. Within the first duration threshold, no selection operation of the first virtual character 80 is received, and the first virtual character 80 may remain in an unlocked state. The user can control the first virtual character 80 to move around a candidate area 1001. The selection operation in the first round in FIG. 10 is similar to that in FIG. 9, and will not be described redundantly here.

FIG. 11 is a schematic diagram of a selection page for a second round according to an embodiment of this disclosure. As shown in FIG. 11, in the selection page, based on a selection order, first virtual character 80 and first virtual character 70 in the first round, as well as second virtual character 60 and second virtual character 50 in the second round, are unlocked. Within a first duration threshold, the first virtual character 80 does not select a candidate area 1101. Then, the first virtual character 80, and the second virtual character 60 and the second virtual character 50 unlocked in the second round together select candidate areas 1101 in the second round. For example, in the second round, a selected candidate area 1102 is determined based on the selection operation of the second virtual character 60. If the first virtual character 80 and the second virtual character 50 do not select candidate areas 1101, the first virtual character 80 and the second virtual character 50 will select, together with virtual characters unlocked in the next round, candidate areas 1101 in the next round.

In an embodiment of this disclosure, in the selection page, the moving speed of at least one of a piece area or a candidate area is determined based on reference information, where the reference information includes at least one of the number of selected candidate areas or a game duration.

At least one of the piece area or the candidate area refers to an area that is in the moving state in the first game page, and may be referred to as a moving area. In other words, in the selection page, the moving speed of the moving area is determined based on the reference information.

For example, the moving speed of the moving area is negatively correlated with the number of selected candidate areas, and also negatively correlated with the game duration. The game duration refers to the elapsed duration of the current selection phase. As the number of unselected candidate areas decreases, the moving speed of at least one of the piece area or the candidate area decreases. Alternatively, as the game duration increases, the moving speed of at least one of the piece area or the candidate area decreases. The following description is made by using as an example in which the piece areas are in the moving state while the candidate areas are in the stationary state.

In an embodiment, the piece areas move at a first speed within the first duration threshold. After the first duration threshold, the piece areas move at a second speed, where the second speed is lower than the first speed.

In another embodiment, virtual characters are unlocked sequentially based on the selection order. The piece areas move at the first speed, and the piece areas move at the second speed in response to receiving a selection operation on a candidate area, where the second speed is lower than the first speed.

In one embodiment, the first speed and the second speed may each be expressed in terms of any one of an angular velocity, a linear velocity, or a rotational speed. When the first speed and the second speed are fixed speeds, the second speed is lower than the first speed. For example, during the circular motion of the piece areas, the rotational speed of the first speed is 8 revolutions per minute, and the rotational speed of the second speed is 6 revolutions per minute. The circular motion of the piece areas means that when the piece areas are arranged circularly, they move clockwise or counterclockwise. When the first speed and the second speed are gradually decreasing speeds, the maximum value of the second speed is less than the minimum value of the first speed. For example, during the entire movement process of the piece areas, the speed of the piece areas decreases uniformly.

In the embodiments of this disclosure, during a game turn, virtual characters are unlocked based on the selection order. The unlocked virtual characters can select candidate areas, and the piece areas corresponding to the candidate areas are in the moving state. The moving state of the piece areas is adjusted based on the unlocking status of the virtual characters or the game duration. The more unlocked virtual characters or the longer the game duration, the smaller the moving speed of the piece areas. Users can observe the movement pattern of the piece areas to select candidate areas. Users who select a candidate area earlier can choose a candidate area they consider advantageous. Since the piece areas are in the moving state, users who select a candidate area later also have an opportunity to compete for the desired pieces. The method for acquiring pieces in the embodiments of this disclosure increases the competitiveness and randomness during the game, while taking into account the gaming experience of each user in the selection order.

In an embodiment of this disclosure, in the selection page, at least one of the piece area or the candidate area moves uniformly at a reference speed. The reference speed is determined based on related information of the virtual character. The manner of determining the reference speed is described in the relevant description above and will not be repeated here.

In an embodiment of this disclosure, when, within a second selection duration, the number of selected candidate areas is equal to that of virtual characters in the current game turn (i.e., the virtual characters have completed the selection of candidate areas), the moving speed of the moving areas (piece areas and/or candidate areas) may gradually decrease until the moving speed of the moving areas (piece areas and/or candidate areas) decreases to 0. To be specific, both the piece areas and the candidate areas are in the stationary state, resulting in a second game page.

In an embodiment of this disclosure, when the number of selected candidate areas is less than a first number threshold, the unselected candidate areas are randomly matched with the virtual characters that have not selected a candidate area. A second game page is displayed based on the result of the random matching. For example, the first number threshold may be equal to the number of virtual characters. For example, the first number threshold may alternatively be less than the number of virtual characters.

For example, when the game duration of the current turn is longer than or equal to the second selection duration, if there are still virtual characters that have not selected a candidate area, an automatic matching mechanism may be triggered. The automatic matching mechanism may automatically match virtual characters with unselected candidate areas. The game duration of the current turn may refer to the elapsed duration of the selection phase of the current turn. In one embodiment, the second selection duration may be a duration set by the game system to detect whether a user has completed the selection operation on a candidate area within the specified time. In one embodiment, before triggering the automatic matching mechanism, a prompt may be displayed in the game page on a user terminal, for example, by means of a sound alert, vibration, or text information, to prompt the user to select a candidate area as soon as possible within the specified time.

During the automatic matching process, candidate areas that have not been selected by virtual characters are obtained. These candidate areas that have not been selected by virtual characters are in one-to-one correspondence with pieces. The candidate areas that have not been selected by virtual characters are matched with the virtual characters to obtain matching results. To be specific, the virtual characters obtain the piece corresponding to the piece areas. After the matching results are obtained, the corresponding second game page is displayed based on the matching results.

For example, within the second selection duration, there are three virtual characters that have not selected a candidate area, and the unselected candidate areas include a first candidate area, a second candidate area, and a third candidate area. The first candidate area, the second candidate area, and the third candidate area respectively correspond to a first piece area, a second piece area, and a third piece area. The first piece area, the second piece area, and the third piece area display piece F, piece B, and piece C, respectively. After the matching mechanism is triggered, the three virtual characters are randomly placed into the first candidate area, the second candidate area, or the third candidate area. The virtual characters placed in the first candidate area, the second candidate area, or the third candidate area may obtain the piece F, the piece B, and the piece C, respectively.

In the embodiments of this disclosure, if there are virtual characters that have not selected a candidate area within the second selection duration, the candidate areas and virtual characters are randomly matched to facilitate the smoothness of the game and the gaming experience of the users.

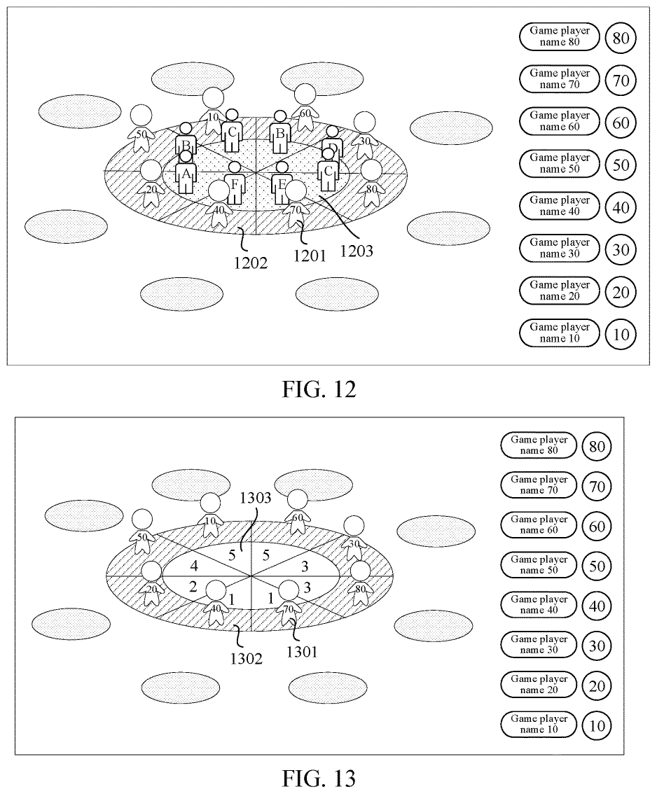

FIG. 12 is a schematic diagram of a second game page according to an embodiment of this disclosure. As shown in FIG. 12, the second game page may include virtual characters 1201, selected candidate areas 1202, and piece areas 1203. The selected candidate areas 1202 and the piece areas 1203 are all in a stationary state. The piece areas 1203 are in one-to-one correspondence with the selected candidate areas 1202, and the selected candidate areas 1202 may be in one-to-one correspondence with the virtual characters 1201.

In an embodiment of this disclosure, displaying the second game page in response to a candidate area being selected when the content displayed in the piece area is piece information includes: displaying a third game page in response to the candidate area being selected, the third game page including a candidate area and a piece area in the stationary state, and the piece area displaying the piece information; and displaying the second game page based on the third game page. In some examples, a third game page is displayed when the number of the selected candidate areas is determined to reach the reference number, the third game page including the plurality of candidate areas and the plurality of piece areas in the stationary state, each one of the plurality of piece areas displaying piece information of a respective piece and corresponding to a respective one of the plurality of candidate areas. In some examples, the second game page is displayed based on the third game page.

Before displaying the second game page, the third game page may further be displayed, and then the second game page is displayed based on the third game page. The process of displaying the second game page based on the third game page may include: displaying the third game page, the third game page including a selected candidate area and a piece area, the piece area displaying the piece information, and the piece area being associated with the selected candidate area; and displaying the second game page when the piece information meets an unlocking condition.

In an embodiment, the piece information meeting the unlocking condition may mean that the piece corresponding to the piece information has been determined. For example, the piece corresponding to the piece information may be determined by a server of the turn-based board game and returned to a terminal, or may be determined by the terminal itself.

For example, when the number of selected candidate areas is equal to that of virtual characters in the current turn (i.e., the virtual characters have completed the selection operations on candidate areas), the moving speed of the moving areas (piece areas and/or candidate areas) may gradually decrease until the moving speed of the moving areas (piece areas and/or candidate areas) decreases to 0. To be specific, the piece areas are in the stationary state, resulting in the third game page. In the third game page, the piece areas are in one-to-one correspondence with the selected candidate areas.

FIG. 13 is a schematic diagram of a third game page according to an embodiment of this disclosure. As shown in FIG. 13, the third game page may include virtual characters 1301, selected candidate areas 1302, and piece areas 1303. The selected candidate areas 1302 and the piece areas 1303 are in a stationary state. The piece areas 1303 are in one-to-one correspondence with the selected candidate areas 1302, and the piece areas 1303 may display piece information (piece levels).

In operation 203, the piece corresponding to a candidate area is assigned to the virtual character that selects the candidate area. For example, a piece corresponding to the respective candidate area is assigned by processing circuitry to a respective one of the one or more virtual characters selecting the candidate area.

In some embodiments, the candidate area may alternatively be referred to as a selectable area. In other words, the piece corresponding to the selectable area is assigned to the virtual character that selects the selectable area.

In an embodiment of this disclosure, the candidate areas selected by virtual characters are in one-to-one correspondence with piece areas. The pieces corresponding to display objects of the piece areas corresponding to the candidate areas are assigned to the virtual characters that select the candidate areas. The display object of a piece area refers to the content displayed in the piece area before the second game page is displayed. The display object of the piece area may be at least one of a piece or piece information. When the display object of the piece area is a piece, the piece itself is assigned to the virtual character that selects the candidate area. When the display object of the piece area is piece information, the piece corresponding to the piece information is assigned to the virtual object that selects the candidate area. In other words, either the piece itself or the piece corresponding to the piece information may be assigned to the corresponding virtual character.

When the display object of a piece area is piece information, after the assignment of the piece information is completed, a piece corresponding to the piece information may be randomly displayed and assigned to the virtual character. With reference to FIG. 13, a virtual character 1301 (taking virtual character 40 as an example) is located in a selected candidate area 1302. The piece area 1303 corresponding to the selected candidate area 1302 displays a piece level of 1. Therefore, a piece at the piece level of 1 is assigned to the virtual character 40.

In the embodiments of this disclosure, the selected candidate areas are in one-to-one correspondence with the piece areas, and the piece areas display the piece information (which may be piece levels). Thus, the piece levels obtained by the virtual characters can be determined. In subsequent game process, users can obtain pieces corresponding to the piece levels. By determining the piece levels via the selected candidate areas and unlocking the corresponding pieces based on the piece levels, the randomness and fun of the game process can be further increased, thereby improving the gaming experience.

When the display object of a piece area is a piece, the piece displayed in the piece area may be directly assigned to the virtual character associated with the corresponding selected region. With reference to FIG. 12, a virtual character 1201 (taking virtual character 40 as an example) is located in a selected candidate area 1202. The piece area 1203 corresponding to the selected candidate area 1202 displays piece F. Therefore, the piece F is assigned to the virtual character 40.

In an embodiment of this disclosure, after the virtual characters obtain the corresponding pieces, battle strategies may be formulated based on the obtained pieces. During a battle turn, the selected pieces are placed in a battle area of a board according to the battle strategies. The current player's piece and the opposing player's piece placed in the battle area of the board may automatically engage in combat. The combat between the pieces does not require manual control by the current user. Instead, the client or server automatically controls the combat between the pieces on both sides based on factors such as positions of the pieces on both sides on the board, piece attributes, piece levels, piece skills, and combined enhancement attributes between pieces, until all pieces on one side are defeated.

Both the virtual character controlled by the current user and the virtual character controlled by the opposing user have health points. After the battle turn ends, the health points of the virtual character controlled by the losing user will be deducted by a particular amount. The particular amount may be determined based on the number of remaining pieces on the winning side, or may be a fixed value. This is not limited in this embodiment. If the health points of the virtual character controlled by a user have not been reduced to zero, the game proceeds to the next round of turn-based combat within the current game battle, and the user continues to battle against one of the other users until the user is eliminated, or until the user becomes the last remaining non-eliminated side and wins the current game battle.

In the embodiments of this disclosure, during the piece assignment process, at least one of the candidate area or the piece area is in the moving state. After a virtual character selects a candidate area, the candidate areas and the piece areas in the stationary state are displayed, and the piece displayed in the piece area corresponding to the candidate area selected by the virtual character is assigned to the virtual character. The randomness of the piece assignment process is improved. By having the candidate areas and/or the piece areas in the moving state, the fun and diversity of the piece assignment process are increased, thereby improving the human-computer interaction efficiency.

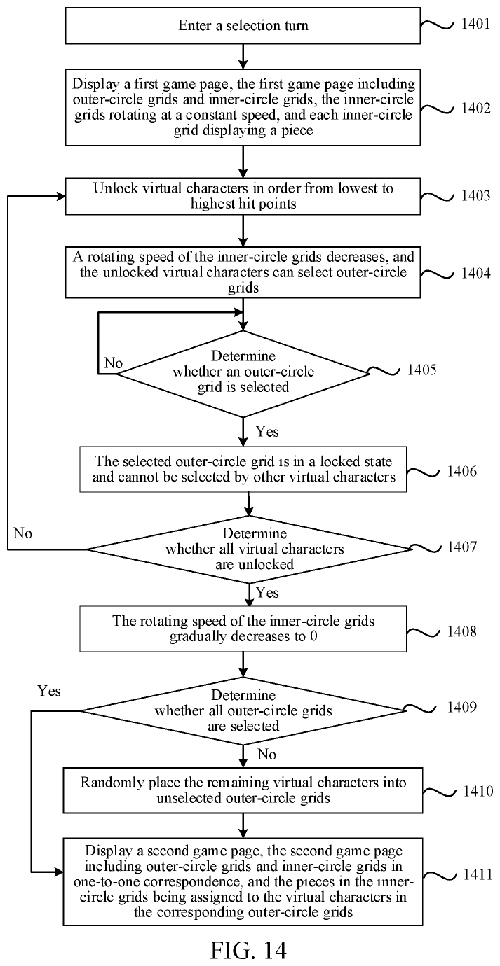

FIG. 14 is a flowchart of a method for piece assignment for a turn-based board game according to an embodiment of this disclosure. The method may be performed by a terminal (the first terminal 110 and the second terminal 130) in the computer system shown in FIG. 1. Taking as an example that piece areas and candidate areas arranged circularly, the piece areas may be referred to as inner-circle grids, and the candidate areas as outer-circle grids. The method includes the following operations.
Operation 1401: Enter a selection turn.

In some embodiments, entering the selection turn may alternatively be referred to as entering a selection phase of a turn in a battle of the turn-based board game.
Operation 1402: Display a first game page, the first game page including outer-circle grids and inner-circle grids, the inner-circle grids rotating at a constant speed, and each inner-circle grid displaying a piece.
Operation 1403: Unlock virtual characters in order from lowest to highest hit points.
Operation 1404: A rotating speed of the inner-circle grids decreases, and the unlocked virtual characters can select outer-circle grids.
Operation 1405: Determine whether an outer-circle grid is selected.

If yes (i.e., the outer-circle grid is selected), operation 1406 is performed: the selected outer-circle grid is in a locked state and is prevented from being selected by other virtual characters. If no (i.e., no outer-circle grid is selected), operation 1405 is performed again.
Operation 1407: Determine whether all virtual characters are unlocked.

If yes (i.e., all virtual characters are unlocked), operation 1408 is performed: the rotating speed of the inner-circle grids gradually decreases to 0. If no (i.e., not all virtual characters are unlocked), operation 1403 is performed again.
Operation 1409: Determine whether all outer-circle grids are selected.

If no (i.e., not all outer-circle grids are selected), operation 1410 is performed to randomly place the remaining virtual characters into the unselected outer-circle grids. If yes (i.e., all outer-circle grids are selected), operation 1411 is performed.
Operation 1411: Display a second game page, the second game page including outer-circle grids and inner-circle grids in one-to-one correspondence, and the pieces in the inner-circle grids being assigned to the virtual characters in the corresponding outer-circle grids.

The operations in FIG. 14 have been described in operations 201 to 203. Reference may be made to the descriptions of the relevant operations, which will not be repeated here.

In the embodiments of this disclosure, during the piece assignment process, the inner-circle grids are in the moving state while the outer-circle grids are in the stationary state. After the virtual characters begin selecting outer-circle grids, the moving speed of the inner-circle grids decreases. When all virtual characters are located in the outer-circle grids, the outer-circle grids and inner-circle grids in the stationary state are displayed. The outer-circle grids are in one-to-one correspondence with the inner-circle grids. The outer-circle grids display the virtual characters, while the inner-circle grids display the pieces, and the pieces in the inner-circle grids are assigned to the virtual characters in the corresponding outer-circle grids. Thus, the unpredictability and randomness of the piece assignment process can be improved. By having the candidate areas and/or the piece areas in the moving state, the fun and diversity of the piece assignment process are increased, thereby helping stimulate the curiosity of game players controlling the virtual characters to participate in the piece assignment process and mobilizing the game players' interactive enthusiasm with the turn-based board game. Thus, the human-computer interaction efficiency is improved.

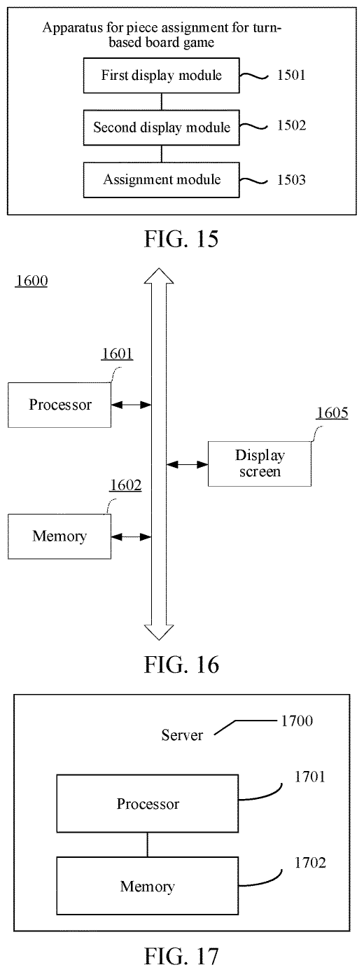

This disclosure further provides an apparatus for piece assignment for a turn-based board game. FIG. 15 is a schematic structural diagram of an apparatus for piece assignment for a turn-based board game according to an embodiment of this disclosure. As shown in FIG. 15, the apparatus includes:
a first display module 1501 configured to display a first game page, the first game page including a piece area and a candidate area configured for selection by a virtual character, and at least one of the piece area or the candidate area being in a moving state;
a second display module 1502 configured to display a second game page in response to the candidate area being selected, the second game page including a candidate area and a piece area in a stationary state, the piece area displaying at least one piece, and one piece corresponding to one candidate area; and
an assignment module 1503 configured to assign a piece corresponding to the candidate area to a virtual character selecting the candidate area.

In an implementation example, at least one of the piece area or the candidate area moves uniformly at a reference speed, the reference speed being determined based on related information of the virtual character; where the related information of the virtual character includes at least one of a number of virtual characters, an attribute value, or a reference resource, and the number of virtual characters is less than or equal to a number of candidate areas.

In an implementation example, the second display module 1502 is further configured to display a selection page, the selection page being configured to display a picture of the virtual character selecting the candidate area and including at least one selected candidate area that is determined based on a selection operation performed by a virtual character in an unlocked state.

In an implementation example, the virtual character in the unlocked state is the virtual character unlocked based on a selection order, the selection order being determined based on at least one of the attribute value or the reference resource of the virtual character.

In an implementation example, the selection page is further configured to display time information, the time information being configured for assisting the virtual character in selecting the candidate area.

In an implementation example, the selection page further includes notification information, the notification information being configured for prompting that the candidate area has been selected.

In an implementation example, display manners of the selected candidate area and an unselected candidate area are different in the selection page.

In an implementation example, the second display module 1502 is further configured to: randomly match unselected candidate areas with virtual characters that have not selected a candidate area when a number of selected candidate areas is less than a first number threshold; and display a second game page based on a result of the random matching.

In an implementation example, in the selection page, a moving speed of at least one of the piece area or the candidate area is determined based on reference information, the reference information including at least one of the number of selected candidate areas or a game duration.

In an implementation example, in the first game page, a content displayed in the piece area includes at least one of a piece or piece information, the piece information including at least one of expense information, level information, or identification information of the piece.

In an implementation example, the first display module 1501 is further configured to: display a voting page, the voting page being configured to vote on the content displayed in the piece area; and determine, based on a voting result of the voting page, the content displayed in the piece area.

In an implementation example, in the first game page, the content displayed in the piece area includes the piece information; and the second display module 1502 is configured to: display a third game page in response to the candidate area being selected, the third game page including a candidate area and a piece area in the stationary state, and the piece area displaying the piece information; and display the second game page based on the third game page.

In an implementation example, the first display module 1501 is further configured to: display a faction selection page, the faction selection page including a plurality of factions and a plurality of reference areas, and at least the plurality of factions or the plurality of reference areas being in the moving state; and
display a faction selection result page when all virtual characters have selected reference areas, the faction selection result page including the plurality of reference areas and the plurality of factions in a stationary state, one faction corresponding to one reference area, the faction corresponding to the one reference area being the faction to which a reference number of virtual characters that have selected the one reference area belong, and the reference number being less than or equal to a second number threshold.

In an implementation example, the candidate area being selected includes: a first number of candidate areas being selected, the first number being the number of virtual characters.

In the embodiments of this disclosure, during the piece assignment process, at least one of the candidate area or the piece area is in the moving state. After a virtual character selects a candidate area, the candidate areas and the piece areas in the stationary state are displayed, and the piece displayed in the piece area corresponding to the candidate area selected by the virtual character is assigned to the virtual character. The randomness of the piece assignment process is improved. By having the candidate areas and/or the piece areas in the moving state, the fun and diversity of the piece assignment process are increased, thereby improving the human-computer interaction efficiency.

When the apparatus provided above implements its functions, the division of the foregoing functional modules is used as an example. In practical use, the foregoing functions may be allocated to and completed by different functional modules as required. To be specific, an internal structure of a device is divided into different functional modules to complete all or part of the functions described above. In addition, the apparatus provided in the foregoing embodiments and the method embodiments belong to the same conception. For a specific implementation process, a reference is made to the method embodiments, and details are not described here again.

FIG. 16 is a schematic structural diagram of a terminal device according to an embodiment of this disclosure. The terminal device 1600 may be any electronic device product that may perform human-computer interaction with a user in one or more manners, for example, via a keyboard, a touch pad, a remote control, voice interaction, a handwriting device, or the like. Examples of the terminal device include a personal computer (PC), a mobile phone, a smartphone, a personal digital assistant (PDA), a wearable device, a pocket PC (PPC), a tablet computer, a smart on-board unit, a smart television, a smart speaker, a smart watch, etc. In some embodiments, the terminal device 1600 may alternatively be referred to as a terminal. For example, the terminal device 1600 may be the first terminal 110, the second terminal 130, or the like in the computer system shown in FIG. 1.

Typically, the terminal device 1600 includes processing circuitry (e.g., a processor 1601) and a memory 1602.

The processor 1601 may include one or more processing cores, such as a 4-core processor or an 8-core processor. The processor 1601 may be implemented in at least one hardware form of digital signal processing (DSP), field programmable gate array (FPGA), and programmable logic array (PLA). The processor 1601 may alternatively include a main processor and a coprocessor. The main processor is a processor configured to process data in an awake state, and is also referred to as a central processing unit (CPU). The coprocessor is a low power consumption processor configured to process the data in a standby state. In some embodiments, the processor 1601 may be integrated with a graphics processing unit (GPU). The GPU is configured to be responsible for rendering and drawing content that a display screen needs to display. In some embodiments, the processors 1601 may further include an artificial intelligence (AI) processor. The AI processor is configured to process computing operations related to machine learning.

The memory 1602 may include one or more computer-readable storage media, which may be non-transitory. The memory 1602 may further include a high-speed random access memory and a non-volatile memory, such as one or more disk storage devices and flash storage devices. In some embodiments, the non-transitory computer-readable storage medium in the memory 1602 is configured to store at least one instruction that is configured to be executed by the processor 1601 to implement the method for piece assignment for a turn-based board game provided by the method embodiments of this disclosure. In some embodiments, a non-transitory computer-readable storage medium may alternatively be referred to as a non-volatile computer-readable storage medium.

In some embodiments, the terminal device 1600 may include a display screen 1605.

The display screen 1605 is configured to display a user interface (UI). The UI may include graphics, text, icons, videos, and any combination thereof. When the display screen 1605 is a touch display screen, the display screen 1605 is further capable of collecting a touch signal on or above a surface of the display screen 1605. The touch signal may be inputted as a control signal to the processor 1601 for processing. In this case, the display screen 1605 may be further configured to provide a virtual button and/or a virtual keyboard, which is also referred to as a soft button and/or a soft keyboard. In some embodiments, there may be one display screen 1605 disposed on a front panel of the terminal device 1600. In some other embodiments, there are at least two display screens 1605 that are respectively disposed on different surfaces of the terminal device 1600 or in a folded design. In some other embodiments, the display screen 1605 may be a flexible display screen that is disposed on a curved surface or a folded surface of the terminal device 1600. Even, the display screen 1605 may alternatively be set in a non-rectangular irregular shape, namely a special-shaped screen. The display screen 1605 may be manufactured by using materials such as a liquid crystal display (LCD) or an organic light-emitting diode (OLED). In some embodiments, a first game page, a second game page, a selection page, and the like are displayed by the display screen 1605.

The structure shown in FIG. 16 constitutes no limitation on the terminal device 1600, and the terminal device may include more or fewer components than those shown in the figure, or some components may be combined, or a different component arrangement may be adopted.

FIG. 17 is a schematic structural diagram of a server according to an embodiment of this disclosure. The server 1700 may vary greatly due to different configurations or performance, and may include processing circuitry (e.g., one or more processors 1701) and one or more memories 1702, where the one or more memories 1702 may include a non-transitory computer-readable storage medium configured to store at least one program code that is loaded and executed by the one or more processors 1701 to implement the method for piece assignment for a turn-based board game provided in one or more foregoing embodiments. The server 1700 may further have components such as a wired or wireless network interface, a keyboard, and an I/O interface to facilitate inputting and outputting. The server 1700 may further include other components for implementing device functions, which will not be described redundantly here.

In an embodiment, further provided is a non-transitory computer-readable storage medium, having at least one program code stored therein that is loaded and executed by processing circuitry (e.g., a processor) to cause a computer to implement the method for piece assignment for a turn-based board game described above.

In one embodiment, the non-transitory computer-readable storage medium may be a read-only memory (ROM), a random access memory (RAM), a compact disc read-only memory (CD-ROM), a magnetic tape, a floppy disk, an optical data storage device, or the like.

In an embodiment, further provided is a computer program or a computer program product, having at least one computer instruction stored therein that is loaded and executed by processing circuitry (e.g., a processor) to cause a computer to implement the method for piece assignment for a turn-based board game described above.

The phrase “a plurality of” mentioned herein means two or more. The term “and/or” describes associations between associated objects, and it indicates three types of relationships. For example, “A and/or B” may indicate that A exists alone, A and B coexist, or B exists alone. The character “/” generally indicates that the associated objects are in an “or” relationship. The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The foregoing are non-limiting embodiments of this disclosure and are not intended to limit this disclosure. Any modification, replacement, improvement, and the like made within the principles of this disclosure shall be included within the scope of this disclosure.

What is claimed is:

1. A method for piece assignment in a computer-implemented interactive environment, the method comprising:
displaying a first game page of the computer-implemented interactive environment, the first game page including a plurality of piece areas and a plurality of corresponding candidate areas, the plurality of candidate areas being selectable by one or more virtual characters, and at least the plurality of piece areas or the plurality of candidate areas being in a moving state;
determining whether a number of selected candidate areas of the plurality of candidate areas selected by the one or more virtual characters reaches a reference number;
displaying a second game page of the computer-implemented interactive environment when the number of the selected candidate areas is determined to reach the reference number, the second game page including the plurality of candidate areas and the plurality of piece areas in a stationary state, each one of the plurality of piece areas displaying a respective piece and corresponding to a respective one of the plurality of candidate areas; and
assigning, by processing circuitry, a piece corresponding to the respective candidate area to a respective one of the one or more virtual characters selecting the candidate area.

2. The method according to claim 1, wherein
the plurality of piece areas or the plurality of candidate areas moves at a reference speed, the reference speed being determined based on related information of the one or more virtual characters;
the related information of the one or more virtual characters includes at least one of a number of the one or more virtual characters, an attribute value of the one or more virtual characters, or a reference resource of the one or more virtual characters; and
the number of the one or more virtual characters is less than or equal to a number of the plurality of candidate areas.

3. The method according to claim 1, further comprising:
displaying a selection page configured to indicate whether each of the plurality of the candidate areas is selectable, and the selection page enabling one of the one or more virtual characters that is in an unlocked state to perform a selection operation on one or more of the plurality of candidate areas indicated as selectable.

4. The method according to claim 3, wherein each one of the one or more virtual characters is set in the unlocked state based on a selection order, the selection order being determined based on at least one of an attribute value or a reference resource of the respective virtual character.

5. The method according to claim 3, wherein the selection page is further configured to display time information configured to assist the one or more virtual characters in selecting respective one or more of the plurality of candidate areas.

6. The method according to claim 3, wherein the selection page further includes notification information indicating whether a candidate area has been selected.

7. The method according to claim 3, wherein the selection page is configured to display a selected candidate area and an unselected candidate area in different manners.

8. The method according to claim 3, wherein, in the selection page, a moving speed of at least the plurality of piece areas or the plurality of candidate areas is determined based on reference information, the reference information including at least one of the number of selected candidate areas or a game duration.

9. The method according to claim 1, further comprising:
randomly matching unselected candidate areas with virtual characters that have not selected a candidate area when a number of selected candidate areas is less than a first number threshold; and
displaying the second game page based on a result of the random matching.

10. The method according to claim 1, wherein, in the first game page, a content displayed in one of the plurality of piece areas includes a piece or piece information of the piece, the piece information including at least one of expense information, level information, or identification information of the piece.

11. The method according to claim 10, further comprising:
displaying a voting page enabling the one or more virtual characters to vote on the content displayed in the piece area; and
determining, based on a voting result of the voting page, the content displayed in the piece area.

12. The method according to claim 10, wherein the displaying the second game page comprises:
displaying a third game page when the number of the selected candidate areas is determined to reach the reference number, the third game page including the plurality of candidate areas and the plurality of piece areas in the stationary state, each one of the plurality of piece areas displaying piece information of a respective piece and corresponding to a respective one of the plurality of candidate areas; and
displaying the second game page based on the third game page.

13. The method according to claim 1, further comprising:
displaying a faction selection page, the faction selection page including a plurality of factions and a plurality of reference areas, and at least the plurality of factions or the plurality of reference areas being in the moving state; and
displaying a faction selection result page when the one or more virtual characters have selected corresponding one or more of the plurality of reference areas, the faction selection result page including the plurality of reference areas and the plurality of factions in the stationary state, each one of the plurality of reference areas in the faction selection result page corresponding to a respective one of the plurality of factions in the faction selection result page.

14. The method according to claim 1, wherein the reference number is a number of the one or more virtual characters.

15. An apparatus for piece assignment in a computer-implemented interactive environment, the apparatus comprising:
processing circuitry configured to:
display a first game page of the computer-implemented interactive environment, the first game page including a plurality of piece areas and a plurality of corresponding candidate areas, the plurality of candidate areas being selectable by one or more virtual characters, and at least the plurality of piece areas or the plurality of candidate areas being in a moving state;
determine whether a number of selected candidate areas of the plurality of candidate areas selected by the one or more virtual characters reaches a reference number;
display a second game page of the computer-implemented interactive environment when the number of the selected candidate areas is determined to reach the reference number, the second game page including the plurality of candidate areas and the plurality of piece areas in a stationary state, each one of the plurality of piece areas displaying a respective piece and corresponding to a respective one of the plurality of candidate areas; and
assign a piece corresponding to the respective candidate area to a respective one of the one or more virtual characters selecting the candidate area.

16. The apparatus according to claim 15, wherein
the plurality of piece areas or the plurality of candidate areas moves at a reference speed, the reference speed being determined based on related information of the one or more virtual characters;
the related information of the one or more virtual characters includes at least one of a number of the one or more virtual characters, an attribute value of the one or more virtual characters, or a reference resource of the one or more virtual characters; and
the number of the one or more virtual characters is less than or equal to a number of the plurality of candidate areas.

17. The apparatus according to claim 15, wherein the processing circuitry is configured to:
display a selection page configured to indicate whether each of the plurality of the candidate areas is selectable, and the selection page enabling one of the one or more virtual characters that is in an unlocked state to perform a selection operation on one or more of the plurality of candidate areas indicated as selectable.

18. The apparatus according to claim 17, wherein each one of the one or more virtual characters is set in the unlocked state based on a selection order, the selection order being determined based on at least one of an attribute value or a reference resource of the respective virtual character.

19. The apparatus according to claim 15, wherein the reference number is a number of the one or more virtual characters.

20. A non-transitory computer-readable storage medium storing instructions, which when executed by a processor, cause the processor to perform a method for piece assignment in a computer-implemented interactive environment, the method comprising:
displaying a first game page of the computer-implemented interactive environment, the first game page including a plurality of piece areas and a plurality of corresponding candidate areas, the plurality of candidate areas being selectable by one or more virtual characters, and at least the plurality of piece areas or the plurality of candidate areas being in a moving state;
determining whether a number of selected candidate areas of the plurality of candidate areas selected by the one or more virtual characters reaches a reference number;
displaying a second game page of the computer-implemented interactive environment when the number of the selected candidate areas is determined to reach the reference number, the second game page including the plurality of candidate areas and the plurality of piece areas in a stationary state, each one of the plurality of piece areas displaying a respective piece and corresponding to a respective one of the plurality of candidate areas; and
assigning a piece corresponding to the respective candidate area to a respective one of the one or more virtual characters selecting the candidate area.
